(19) United States
(12) Patent Application Publication
(10) Pub. No.: US 2022/0263669 A1
(43) Pub. Date: Aug. 18, 2022

(54) METHOD OF USING A SIDE CHANNEL

(71) Applicant: nChain Holdings Limited, St. John's (AG)

(72) Inventors: Wei ZHANG, London (GB); Jack DAVIES, London (GB); Craig WRIGHT, London (GB)

(21) Appl. No.: 17/612,172

(22) PCT Filed: Apr. 21, 2020
(86) PCT No.: PCT/IB2020/053765

§ 371 Date: Nov. 17, 2021

(30) Foreign Application Priority Data
May 24, 2019 (GB) 1907343.6

(51) Int. Cl. H04L 9/00; H04L 9/32; G06F 21/42

(52) U.S. Cl. CPC H04L 9/50; G06F 21/42; H04L 9/3247; H04L 9/3236

(57) ABSTRACT

A procedure comprising: a) formulating a proposed instance of a first transaction and sending it to the second party over a side channel, the proposed instance being formulated according to a transaction protocol recognized by the nodes of a blockchain network for validating transactions, and specifying a set of one or more values of a respective one or more parameters of the transaction including at least said amount of the digital asset, b) upon the second party not accepting the proposed instance of the first transaction, receiving back over the side channel a counter-proposed instance of the first transaction, the counter-proposed instance also being formulated according to the transaction protocol, but specifying a modified set of one or more values of the one or more transaction parameters, and c) the first party selecting whether to accept the counter-proposed instance received in b).

### CROSS REFERENCES TO RELATED APPLICATIONS

This application is the U.S. National Stage of International Application No. PCT/IB2020/053765 filed on Apr. 21, 2020, which claims the benefit of United Kingdom Patent Application No. 1907343.6, filed on May 24, 2019, the contents of which are incorporated herein by reference in their entireties.

### TECHNICAL FIELD

The present disclosure relates to a method of using an “off-chain” side channel in the context of a blockchain based system.

### BACKGROUND

A blockchain refers to a form of distributed data structure, wherein a duplicate copy of the blockchain is maintained at each of a plurality of nodes in a peer-to-peer (P2P) network. The blockchain comprises a chain of blocks of data, wherein each block comprises one or more transactions. Each transaction may point back to a preceding transaction in a sequence. Transactions can be submitted to the network to be included in new blocks by a process known as “mining”, which involves each of a plurality of mining nodes competing to perform “proof-of-work”, i.e. solving a cryptographic puzzle based on a pool of the pending transactions waiting to be included in blocks.

Conventionally the transactions in the blockchain are used to convey a digital asset, i.e. data acting as a store of value. However, a blockchain can also be exploited in order to layer additional functionality on top of the blockchain. For instance, blockchain protocols may allow for storage of additional user data in an output of a transaction. Modern blockchains are increasing the maximum data capacity that can be stored within a single transaction, enabling more complex data to be incorporated. For instance this may be used to store an electronic document in the blockchain, or even audio or video data.

Each node in the network can have any one, two or all of three roles: forwarding, mining and storage. Forwarding nodes each propagate (valid) transactions to one or more other nodes, thus between them propagating the transactions throughout the nodes of the network. Mining nodes each compete to perform the mining of transactions into blocks. Storage nodes each store their own copy of the mined blocks of the blockchain. In order to have a transaction recorded in the blockchain, a party sends the transaction to one of the nodes of the network to be propagated. Mining nodes which receive the transaction may race to mine the transaction into a new block. Each node is configured to respect the same node protocol, which will include one or more conditions for a transaction to be valid. Invalid transactions will not be propagated nor mined into blocks. Assuming the transaction is validated and thereby accepted onto the blockchain, the additional user data will thus remain stored at each of the nodes in the P2P network as an immutable public record.

The miner who successfully solved the proof-of-work puzzle to create the latest block is typically rewarded with a transaction called a “generation transaction” generating a new amount of the digital asset. A transaction may optionally also specify an extra mining fee for the successful miner. The proof-of work incentivises miners not to cheat the system by including double-spending transactions in their blocks, since it requires a large amount of compute resource to mine a block, and a block that includes an attempt to double spend is likely not be accepted by other nodes.

In an “output-based” model (sometimes referred to as a UTXO-based model), the data structure of a given transaction comprises one or more inputs and one or more outputs. Any spendable output comprises an element specifying an amount of the digital asset, this element sometimes being referred to as a UTXO (“unspent transaction output”). The output may further comprise a locking script specifying a condition for redeeming the output. Each input comprises a pointer to such an output in a preceding transaction, and may further comprise an unlocking script for unlocking the locking script of the pointed-to output. So consider a pair of transactions, call them a first and a second transaction. The first transaction comprises at least one output specifying an amount of the digital asset, and comprising a locking script defining one or more conditions of unlocking the output. The second transaction comprises at least one input, comprising a pointer to the output of the first transaction, and an unlocking script for unlocking the output of the first transaction.

In such a model, when the second transaction is sent to the P2P network to be propagated and recorded in the blockchain, one of the requirements for validity applied at each node will be that the unlocking script meets the requirement defined in the locking script of the first transaction. Another condition for the validity of the second transaction will be that the output of the first transaction has not already been redeemed by another valid transaction. Any node that finds the second transaction invalid according to any of these conditions will not propagate it nor include it for mining into a block to be recorded in the blockchain.

Say that the second transaction is to convey an amount of digital asset from a first party (“Alice”) to a second party (“Bob”). One of the criteria defined in the locking script of the preceding, first transaction is typically that the unlocking script of the second transaction contains a cryptographic signature of Alice. The signature has to be produced by Alice signing a part of the target transaction. Which part this is may be flexibly defined by the unlocking script, or may be an inherent feature of the node protocol, depending on the protocol being used. Nonetheless, the part to be signed typically excludes some other part of the target transaction, e.g. some or all of the unlocking script itself.

This creates the possibility of “malleability”. I.e. before mining, the part of the target transaction which is not signed can be modified (“malleated”) without invalidating the transaction. Malleability is a known concept in cryptography generally, where it is usually seen as a security concern whereby a message can be maliciously modified but still accepted as genuine. In the context of a blockchain, malleability is not necessarily a concern but is merely known as a curious artefact whereby a certain part of a transaction can be modified without invalidating it.

Recently a proposal has been made to deliberately exploit malleability in order to use a transaction as a carrier of media data. The data content can be included in the unlocking script of a transaction, and this transaction is then sent between parties over a side channel called a “payment channel”. One of the parties then malleates the transaction to remove the data, and sends the malleated version onward to the P2P network to be mined (whereas if the data was not removed then the transaction would bloat the blockchain, and typically also require a higher mining fee, since the reward required by miners to accept a transaction typically scales with the size of the transaction in bytes or kilobytes).

It is also known to establish a side channel, sometimes referred to as a “payment channel”, in order to send a complete, valid transaction between parties “off chain” before the transaction is broadcast to the P2P network to be recorded in the blockchain. The side channel is separate from the P2P overlay network, and hence any transaction sent over the side channel will not (yet) be propagated throughout the network for recordal in the blockchain until one of the parties chooses to publish it to the network.

### SUMMARY

There is an issue with existing arrangements in that they can lead to network congestion. For instance, consider a scenario where Alice wants to have a transaction mined into a block and hence stored on the blockchain, but she does not know what mining fee is likely to be accepted at the present time. This may be especially (but not exclusively) an issue if the transaction in question contains a data payload. Mining fees typically scale with the amount of data included in the transaction, which as mentioned can now include a data payload in order to store content on the chain. E.g. perhaps Alice wants to have a document or movie clip stored on the chain. If the mining fee is not sufficient then, even if the transaction is technically valid, no miners will accept the transaction (the protocol does not force miners to accept valid transactions, they must be incentivized to do so).

Conventionally, Alice will have to start by publishing her transaction to the P2P network offering only a relatively low mining fee, then wait to see if it gets mined into a block, and if not publish another instance of the transaction offering a slightly higher fee, and so forth, until the transaction eventually gets accepted for mining and included in a block. This leads to network congestion due to the publication of many transactions that will never be accepted for mining.

In accordance with embodiments disclosed herein, this can be mitigated by having Alice negotiate a mining fee in advance with Bob over a side channel. Once the amount is agreed, Alice or Bob publishes only the agreed instance of the transaction to the network specifying the agreed amount (and in embodiments the locktime could also be another negotiated condition). A side channel used in this way may be referred to herein as a negotiation channel (though it is not excluded that the same channel could also be used for additional purposes as well).

However, there is a technical issue with realizing a negotiation channel, namely one of interoperability. Many different types of client application are in circulation for accessing a given P2P network and blockchain. E.g. the types could be clients made by different developers, or different releases of the client made by a given developer. It would be undesirable, and may not even be practicable, to coordinate that Alice and Bob (or any two arbitrary parties who may wish to negotiate) run client applications that recognize the same communication protocol for formatting messages to be sent over a side channel. However, the one protocol that Alice and Bob's clients must always have in common is the same transaction protocol. Hence the present disclosure provides a method for negotiating over a side channel using a scheme of template transactions formatted according to a transaction protocol of the network.

A similar mechanism could also be used for other negotiations between Alice and Bob, not necessarily just in the scenario where Bob is a miner.

According to one aspect disclosed herein, there is provided a computer-implemented method for recording in a blockchain at least a first transaction transferring an amount of a digital asset from a first party to a second party, wherein a copy of the blockchain is maintained across at least some of a network of nodes. The method comprises, at computer equipment of the first party: establishing a side channel separate from said network, the side channel being established between a first application on the computer equipment of the first party and a second application on computer equipment of the second party; and performing a negotiation procedure. This procedure comprises: a) formulating a proposed instance of the first transaction and sending the proposed instance to the second party over the side channel, the proposed instance being formulated according to a transaction protocol recognized by the nodes of the network for validating transactions, and specifying a set of one or more values of a respective one or more parameters of the transaction including at least said amount of the digital asset, b) upon the second party not accepting the proposed instance of the first transaction, receiving back over the side channel a counter-proposed instance of the first transaction, the counter-proposed instance also being formulated according to the transaction protocol, but specifying a modified set of one or more values of the one or more transaction parameters, and c) the first party selecting whether to accept the counter-proposed instance received in b).

The modified set of values may modify one, some or all of the values compared to the first set. The parameters whose values are modified may comprise the amount of the digital asset, and/or one or more other parameters such as a lock time.

In embodiments, c) may comprise: upon selecting not to accept the counter-proposed instance received in b), formulating a further counter-proposed instance of the first transaction and sending the further counter-proposed instance to the second party over the side channel for the second party to accept, the further counter-proposed instance again being formulated according to the transaction protocol but specifying a further set of one or more values of the one or more transaction parameters.

In embodiments, at least in a first occurrence of b), the second party may not accept the further counter-proposed transaction. In this case, instead following c), the procedure returns to b) and continues from b) until one of the parties accepts one of the counter-proposed transactions or further counter-proposed transactions. In some cases, the continuation of the procedure may comprise at least one repeated occurrence of both b) and c).

The further modified set of values may modify one, some or all of the values compared to the previously modified set. Again the parameters whose values are modified may comprise the amount of the digital asset, and/or one or more other parameters such as a lock time.

In embodiments, the acceptance comprises: the accepted instance of the first transaction being sent to be propagated over the network and thereby recorded in the blockchain.

Two (or more) transactions may be said herein to be instances of (substantially) the same transaction if both contain an input that references the same output (e.g. UTXO) of the same source transaction (or “zeroth” transaction). They may redeem that input based on meeting the same unlocking condition. In embodiments they may however contain different input signatures (i.e. the signed message in either instance is non-identical).

For each of a plurality of transactions including the first transaction, at least some nodes of the network are configured to propagate each transaction on condition of the transaction being valid and at least some nodes are configured to record each transaction in the copy of the blockchain at that node on condition of the transaction being valid. In an output-based model, the validity of a second or target transaction is conditional on the unlocking script unlocking the output of the first transaction. Typically a transaction is also only deemed valid if the total value of the digital asset pointed to by the total of its one or more inputs is at least equal to the total value of the digital asset specified in the total of its one or more outputs. Further, each node in the network is also configured such that, once one of the instances is validated at any given node, then any other instances would be deemed invalid by that node and hence not propagated nor recorded in the blockchain by the node.

Once the output of a source transaction has been found at a given node to be validly redeemed by a subsequent transaction, then any other instance of the subsequent transaction would be deemed invalid at that node. The instances of the first transaction (e.g. call them Tx₁, Tx₁′, Tx₁″, . . . ) would be recognized by each node of the network as instances of substantially the same transaction, because each instance has an input pointing to the same output of the same preceding source transaction (or “zeroth” transaction, labelled Tx₀ in the following examples). This means that, as soon as one instance of the first transaction (e.g. one of Tx₁, Tx₁′, . . . ) is mined, then the output of the source transaction (e.g. Tx₀) is consumed, and therefore cannot be consumed by any other instance. Hence only one instance can be recorded in the blockchain. Further, once one of the instances of the first transaction is found at any given node to be validly redeemed by any version of the second or target transaction (e.g. Txₚ in the later examples), then any further version of that second transaction attempting to redeem any instances of the first transaction would be deemed invalid by that node, and hence not propagated nor recorded in the blockchain by that node.

In embodiments, the proposed instance of the first transaction in a) may take the form of a template transaction having a complete part and an incomplete part, and therefore not yet being valid according to the node protocol. In this case the proposed transaction is said to be formulated according to the transaction protocol at least in that the complete part is formulated according to the transaction protocol. In such embodiments, the accepted instance has the incomplete parted completed by the first and/or second party.

In some embodiments, the second party may be a miner, and said amount of the digital asset providing a payment for the second party to perform a proof-of-work operation to have a version of a second transaction comprising a data payload included in a block of the blockchain. In this case the locking script requires at least that an unlocking script in an input of the second transaction comprises the data payload in order to redeem the payment.

E.g. the data payload may comprise a document comprising text, and/or a media content comprising audio and/or video.

In particularly advantageous (but not essential) embodiments, the data payload may be conveyed from the first party in a part of one of the instances of the first transaction. Preferably it is conveyed in a part that is not required to be signed, thereby enabling the data payload to be removed from the first transaction before being sent to be propagated over the network.

According to further aspects disclosed herein, there are provided a program for performing the method, and/or computer equipment of the second party programmed to perform the method.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3 is another schematic block diagram of a system for implementing a blockchain, FIG. 3A is another schematic block diagram of a system for implementing a blockchain, FIG. 4 is a schematic block diagram of a client application,

FIG. 5 is a schematic mock-up of an example user interface that may be presented by the client application of FIG. 4,

FIG. 6 is a schematic illustration of a set of transactions,

FIG. 7 is a schematic illustration of a set of template transaction instances for negotiating over a side channel,

FIG. 8 is a schematic illustration of another set of template transaction instances for negotiating over a side channel, and

FIG. 9 is a signalling chart showing a method of conveying data from a first party to a second party.

### DETAILED DESCRIPTION OF EMBODIMENTS

### System Overview

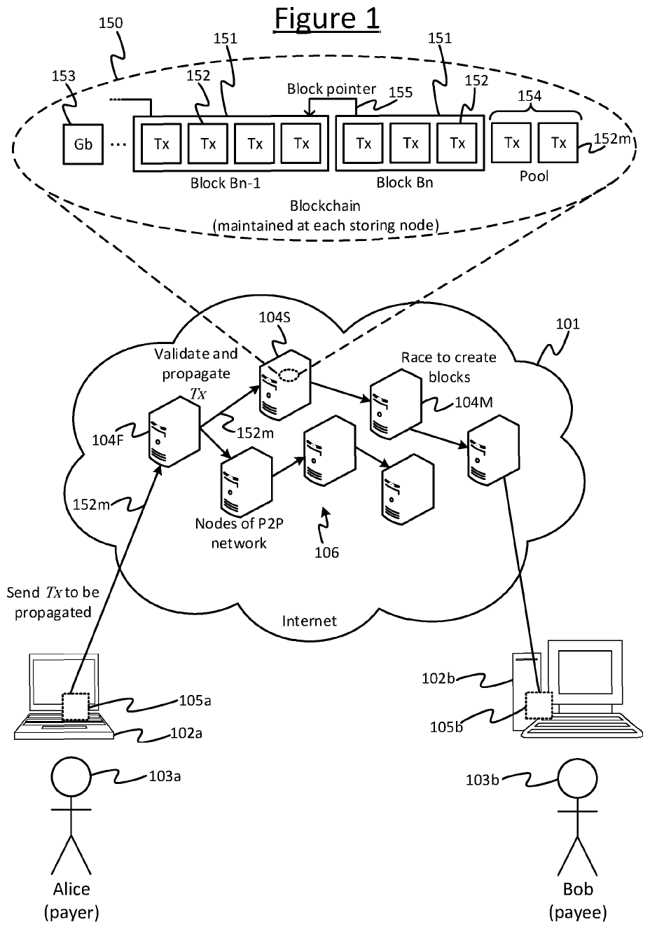

FIG. 1 shows an example system 100 for implementing a blockchain 150. The system 100 comprises a packet-switched network 101, typically a wide-area internetwork such as the Internet. The packet-switched network 101 comprises a plurality of nodes 104 arranged to form a peer-to-peer (P2P) overlay network 106 within the packet-switched network 101. Each node 104 comprises computer equipment of a peers, with different ones of the nodes 104 belonging to different peers. Each node 104 comprises processing apparatus comprising one or more processors, e.g. one or more central processing units (CPUs), accelerator processors, application specific processors and/or field programmable gate arrays (FPGAs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of nodes in the P2P network 160. Each block 151 in the chain comprises one or more transactions 152, wherein a transaction in this context refers to a kind of data structure. The nature of the data structure will depend on the type of transaction protocol used as part of a transaction model or scheme. A given blockchain will typically use one particular transaction protocol throughout. In one common type of transaction protocol, the data structure of each transaction 152 comprises at least one input and at least one output. Each output specifies an amount representing a quantity of a digital asset belonging to a user 103 to whom the output is cryptographically locked (requiring a signature of that user in order to be unlocked and thereby redeemed or spent). Each input points back to the output of a preceding transaction 152, thereby linking the transactions.

At least some of the nodes 104 take on the role of forwarding nodes 104F which forward and thereby propagate transactions 152. At least some of the nodes 104 take on the role of miners 104M which mine blocks 151. At least some of the nodes 104 take on the role of storage nodes 104S (sometimes also called “full-copy” nodes), each of which stores a respective copy of the same blockchain 150 in their respective memory. Each miner node 104M also maintains a pool 154 of transactions 152 waiting to be mined into blocks 151. A given node 104 may be a forwarding node 104, miner 104M, storage node 104S or any combination of two or all of these.

In a given present transaction 152j, the (or each) input comprises a pointer referencing the output of a preceding transaction 152i in the sequence of transactions, specifying that this output is to be redeemed or “spent” in the present transaction 152j. In general, the preceding transaction could be any transaction in the pool 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the signature of the user 103a to whom the output of the preceding transaction 152i is locked. In turn, the output of the present transaction 152j can be cryptographically locked to a new user 103b. The present transaction 152j can thus transfer the amount defined in the input of the preceding transaction 152i to the new user 103b as defined in the output of the present transaction 152j. In some cases a transaction 152 may have multiple outputs to split the input amount between multiple users (one of whom could be the original user 103a in order to give change). In some cases transaction can also have multiple inputs to gather together the amounts from multiple outputs of one or more preceding transactions, and redistribute to one or more outputs of the current transaction.

The above may be referred to as an “output-based” transaction protocol, sometimes also referred to as an unspent transaction output (UTXO) type protocol (where the outputs are referred to as UTXOs). A user's total balance is not defined in any one number stored in the blockchain, and instead the user needs a special “wallet” application 105 to collate the values of all the UTXOs of that user which are scattered throughout many different transactions 152 in the blockchain 151.

An alternative type of transaction protocol may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored by the miners separate to the blockchain and is updated constantly. The present disclosure relates to an output-based model rather than account-based.

With either type of transaction protocol, when a user 103 wishes to enact a new transaction 152j, then he/she sends the new transaction from his/her computer terminal 102 to one of the nodes 104 of the P2P network 106 (which nowadays are typically servers or data centres, but could in principle be other user terminals). This node 104 checks whether the transaction is valid according to a node protocol which is applied at each of the nodes 104. The details of the node protocol will correspond to the type of transaction protocol being used in the blockchain 150 in question, together forming the overall transaction model. The node protocol typically requires the node 104 to check that the cryptographic signature in the new transaction 152j matches the expected signature, which depends on the previous transaction 152i in an ordered sequence of transactions 152. In an output-based case, this may comprise checking that the cryptographic signature of the user included in the input of the new transaction 152j matches a condition defined in the output of the preceding transaction 152i which the new transaction spends, wherein this condition typically comprises at least checking that the cryptographic signature in the input of the new transaction 152j unlocks the output of the previous transaction 152i to which the input of the new transaction points. In some transaction protocols the condition may be at least partially defined by a custom script included in the input and/or output. Alternatively it could simply be a fixed by the node protocol alone, or it could be due to a combination of these. Either way, if the new transaction 152j is valid, the current node forwards it to one or more others of the nodes 104 in the P2P network 106. At least some of these nodes 104 also act as forwarding nodes 104F, applying the same test according to the same node protocol, and so forward the new transaction 152j on to one or more further nodes 104, and so forth. In this way the new transaction is propagated throughout the network of nodes 104.

In an output-based model, the definition of whether a given output (e.g. UTXO) is spent is whether it has yet been validly redeemed by the input of another, onward transaction 152j according to the node protocol. Another condition for a transaction to be valid is that the output of the preceding transaction 152i which it attempts to spend or redeem has not already been spent/redeemed by another valid transaction. Again if not valid, the transaction 152j will not be propagated or recorded in the blockchain. This guards against double-spending whereby the spender tries to spend the output of the same transaction more than once.

In addition to validation, at least some of the nodes 104M also race to be the first to create blocks of transactions in a process known as mining, which is underpinned by “proof of work”. At a mining node 104M, new transactions are added to a pool of valid transactions that have not yet appeared in a block. The miners then race to assemble a new valid block 151 of transactions 152 from the pool of transactions 154 by attempting to solve a cryptographic puzzle. Typically this comprises searching for a “nonce” value such that when the nonce is concatenated with the pool of transactions 154 and hashed, then the output of the hash meets a predetermined condition. E.g. the predetermined condition may be that the output of the hash has a certain predefined number of leading zeros. A property of a hash function is that it has an unpredictable output with respect to its input. Therefore this search can only be performed by brute force, thus consuming a substantive amount of processing resource at each node 104M that is trying to solve the puzzle.

The first miner node 104M to solve the puzzle announces this to the network 106, providing the solution as proof which can then be easily checked by the other nodes 104 in the network (once given the solution to a hash it is straightforward to check that it causes the output of the hash to meet the condition). The pool of transactions 154 for which the winner solved the puzzle then becomes recorded as a new block 151 in the blockchain 150 by at least some of the nodes 104 acting as storage nodes 104S, based on having checked the winner's announced solution at each such node. A block pointer 155 is also assigned to the new block 151n pointing back to the previously created block 151n−1 in the chain. The proof-of-work helps reduce the risk of double spending since it takes a large amount of effort to create a new block 151, and as any block containing a double spend is likely to be rejected by other nodes 104, mining nodes 104M are incentivised not to allow double spends to be included in their blocks. Once created, the block 151 cannot be modified since it is recognized and maintained at each of the storing nodes 104S in the P2P network 106 according to the same protocol. The block pointer 155 also imposes a sequential order to the blocks 151. Since the transactions 152 are recorded in the ordered blocks at each storage node 104S in a P2P network 106, this therefore provides an immutable public ledger of the transactions.

Note that different miners 104M racing to solve the puzzle at any given time may be doing so based on different snapshots of the unmined transaction pool 154 at any given time, depending on when they started searching for a solution. Whoever solves their respective puzzle first defines which transactions 152 are included in the next new block 151n, and the current pool 154 of unmined transactions is updated. The miners 104M then continue to race to create a block from the newly defined outstanding pool 154, and so forth. A protocol also exists for resolving any “fork” that may arise, which is where two miners 104M solve their puzzle within a very short time of one another such that a conflicting view of the blockchain gets propagated. In short, whichever prong of the fork grows the longest becomes the definitive blockchain 150.

In most blockchains the winning miner 104M is automatically rewarded with a special kind of new transaction which creates a new quantity of the digital asset out of nowhere (as opposed to normal transactions which transfer an amount of the digital asset from one user to another). Hence the winning node is said to have “mined” a quantity of the digital asset. This special type of transaction is sometime referred to as a “generation” transaction. It automatically forms part of the new block 151n. This reward gives an incentive for the miners 104M to participate in the proof-of-work race. Often a regular (non-generation) transaction 152 will also specify an additional transaction fee in one of its outputs, to further reward the winning miner 104M that created the block 151n in which that transaction was included.

Due to the computational resource involved in mining, typically at least each of the miner nodes 104M takes the form of a server comprising one or more physical server units, or even whole a data centre. Each forwarding node 104M and/or storage node 104S may also take the form of a server or data centre. However in principle any given node 104 could take the form of a user terminal or a group of user terminals networked together.

The memory of each node 104 stores software configured to run on the processing apparatus of the node 104 in order to perform its respective role or roles and handle transactions 152 in accordance with the node protocol. It will be understood that any action attributed herein to a node 104 may be performed by the software run on the processing apparatus of the respective computer equipment. Also, the term “blockchain” as used herein is a generic term that refers to the kind of technology in general, and does not limit to any particular proprietary blockchain, protocol or service.

Also connected to the network 101 is the computer equipment 102 of each of a plurality of parties 103 in the role of consuming users. These act as payers and payees in transactions but do not necessarily participate in mining or propagating transactions on behalf of other parties. They do not necessarily run the mining protocol. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application or software 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective user party 103 to create, sign and send transactions 152 to be propagated throughout the network of nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

The instance of the client application 105 on each computer equipment 102 is operatively coupled to at least one of the forwarding nodes 104F of the P2P network 106. This enables the wallet function of the client 105 to send transactions 152 to the network 106. The client 105 is also able to contact one, some or all of the storage nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. Each node 104 runs software configured to validate transactions 152 according to a node protocol, and in the case of the forwarding nodes 104F to forward transactions 152 in order to propagate them throughout the network 106. The transaction protocol and node protocol correspond to one another, and a given transaction protocol goes with a given node protocol, together implementing a given transaction model. The same transaction protocol is used for all transactions 152 in the blockchain 150 (though the transaction protocol may allow different subtypes of transaction within it). The same node protocol is used by all the nodes 104 in the network 106 (though it many handle different subtypes of transaction differently in accordance with the rules defined for that subtype, and also different nodes may take on different roles and hence implement different corresponding aspects of the protocol).

As mentioned, the blockchain 150 comprises a chain of blocks 151, wherein each block 151 comprises a set of one or more transactions 152 that have been created by a proof-of-work process as discussed previously. Each block 151 also comprises a block pointer 155 pointing back to the previously created block 151 in the chain so as to define a sequential order to the blocks 151. The blockchain 150 also comprises a pool of valid transactions 154 waiting to be included in a new block by the proof-of-work process. Each transaction 152 comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one of the one or more forwarding nodes 104F to which she is connected. E.g. this could be the forwarding node 104F that is nearest or best connected to Alice's computer 102. When any given node 104 receives a new transaction 152j, it handles it in accordance with the node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any storage node 104S that receives the transaction 152j will add the new validated transaction 152 to the pool 154 in the copy of the blockchain 150 maintained at that node 104S. Further, any forwarding node 104F that receives the transaction 152j will propagate the validated transaction 152 onward to one or more other nodes 104 in the P2P network 106. Since each forwarding node 104F applies the same protocol, then assuming the transaction 152j is valid, this means it will soon be propagated throughout the whole P2P network 106.

Once admitted to the pool 154 in the copy of the blockchain 150 maintained at one or more storage nodes 104, then miner nodes 104M will start competing to solve the proof-of-work puzzle on the latest version of the pool 154 including the new transaction 152 (other miners 104M may still be trying to solve the puzzle based on the old view of the pool 154, but whoever gets there first will define where the next new block 151 ends and the new pool 154 starts, and eventually someone will solve the puzzle for a part of the pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different nodes 104 may receive different instances of a given transaction first and therefore have conflicting views of which instance is ‘valid’ before one instance is mined into a block 150, at which point all nodes 104 agree that the mined instance is the only valid instance. If a node 104 accepts one instance as valid, and then discovers that a second instance has been recorded in the blockchain 150 then that node 104 must accept this and will discard (i.e. treat as invalid) the unmined instance which it had initially accepted.

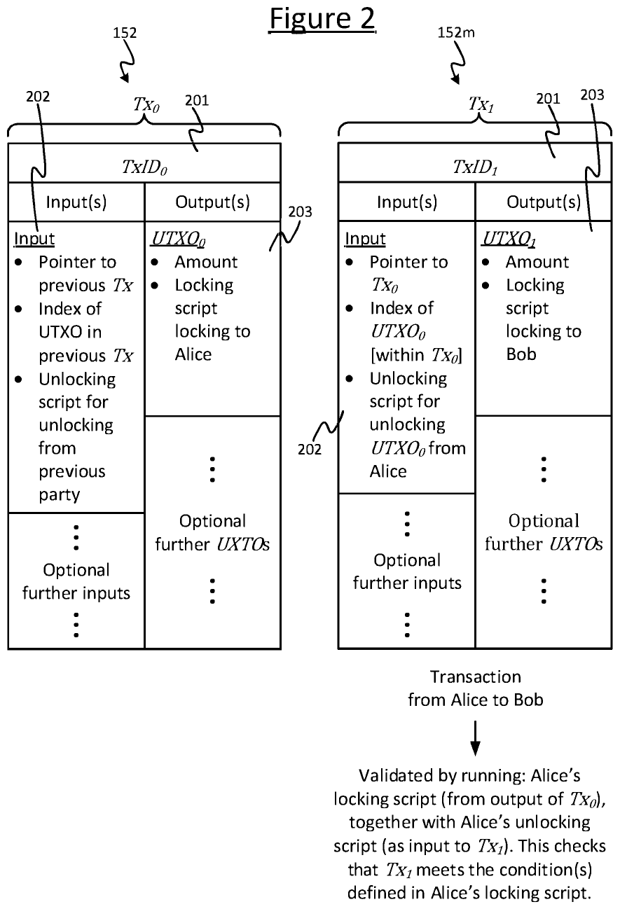

FIG. 2 illustrates an example transaction protocol. This is an example of an UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this not limiting to all possible embodiments.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO specifies an amount of a digital asset (a store of value). It may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the miners 104M.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just an arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in the blockchain 150 at the time when Alice creates her new transaction Tx₁, or at least by the time she sends it to the network 106. It may already have been included in one of the blocks 151 at that time, or it may be still waiting in the pool 154 in which case it will soon be included in a new block 151. Alternatively Tx₀ and Tx₁ could be created and sent to the network 102 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given node 104. Nevertheless, a subsequent transaction (the descendent transaction or “child”) which points to a preceding transaction (the antecedent transaction or “parent”) will not be validated until and unless the parent transaction is validated. A child that arrives at a node 104 before its parent is considered an orphan. It may be discarded or buffered for a certain time to wait for the parent, depending on the node protocol and/or miner behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S). The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains the public key PA from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). What data (or “message”) needs to be signed by Alice to provide a valid signature may be defined by the locking script, or by the node protocol, or by a combination of these.

When the new transaction Tx₁ arrives at a node 104, the node applies the node protocol. This comprises running the locking script and unlocking script together to check whether the unlocking script meets the condition defined in the locking script (where this condition may comprise one or more criteria). In embodiments this involves concatenating the two scripts:

<Sig P_{A}>||[Checksig P_{A}]

where “| |” represents a concatenation and “< . . . >” means place the data on the stack, and “[ . . . ]” is a function comprised by the unlocking script (in this example a stack-based language). When run together, the scripts use the public key P_{A} of Alice, as included in the locking script in the output of Tx₀, to authenticate that the locking script in the input of Tx₁ contains the signature of Alice signing the expected portion of data. The expected portion of data itself (the “message”) also needs to be included in Tx₀ order to perform this authentication. In embodiments the signed data comprises the whole of Tx₀ (so a separate element does to need to be included specifying the signed portion of data in the clear, as it is already inherently present).

The details of authentication by public-private cryptography will be familiar to a person skilled in the art. Basically, if Alice has signed a message by encrypting it with her private key, then given Alice's public key and the message in the clear (the unencrypted message), another entity such as a node 104 is able to authenticate that the encrypted version of the message must have been signed by Alice. Signing typically comprises hashing the message, signing the hash, and tagging this onto the clear version of the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the node 104 deems Tx₁ valid. If it is a storage node 104S, this means it will add it to the pool of transactions 154 awaiting proof-of-work. If it is a forwarding node 104F, it will forward the transaction Tx₁ to one or more other nodes 104 in the network 106, so that it will be propagated throughout the network. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the node 104 also needs to check whether the referenced UTXO in the preceding transaction Tx₀ is already spent (has already formed a valid input to another valid transaction). This is one reason why it is important for the blockchain 150 to impose a defined order on the transactions 152. In practice a given node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor mined into blocks 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the winning miner, because nowadays the reward of the generation transaction alone is not typically sufficient to motivate mining. If Alice does not include a fee for the miner, Tx₀ will likely be rejected by the miner nodes 104M, and hence although technically valid, it will still not be propagated and included in the blockchain 150 (the miner protocol does not force miners 104M to accept transactions 152 if they don't want). In some protocols, the mining fee does not require its own separate output 203 (i.e. does not need a separate UTXO). Instead any different between the total amount pointed to by the input(s) 202 and the total amount of specified in the output(s) 203 of a given transaction 152 is automatically given to the winning miner 104. E.g. say a pointer to UTXO₀ is the only input to Tx₁, and Tx₁ has only one output UTXO₁ . If the amount of the digital asset specified in UTXO₀ is greater than the amount specified in UTXO₁, then the difference automatically goes to the winning miner 104M. Alternatively or additionally however, it is not necessarily excluded that a miner fee could be specified explicitly in its own one of the UTXOs 203 of the transaction 152.

Alice and Bob's digital assets consist of the unspent UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the storage nodes 104S, e.g. the storage node 104S that is closest or best connected to the respective party's computer equipment 102.

Note that the script code is often represented schematically (i.e. not the exact language). For example, one may write [Checksig PA] to mean [Checksig PA]=OP_DUP OP_HASH160 <H(P_{A})>OP_EQUALVERIFY OP_CHECKSIG. “OP_ . . . ” refers to a particular opcode of the Script language. OP_CHECKSIG (also called “Checksig”) is a Script opcode that takes two inputs (signature and public key) and verifies the signature's validity using the Elliptic Curve Digital Signature Algorithm (ECDSA). At runtime, any occurrences of signature (‘sig’) are removed from the script but additional requirements, such as a hash puzzle, remain in the transaction verified by the ‘sig’ input. As another example, OP_RETURN is an opcode of the Script language for creating an unspendable output of a transaction that can store metadata within the transaction, and thereby record the metadata immutably in the blockchain 150. E.g. the metadata could comprise a document which it is desired to store in the blockchain.

The signature P_{A} is a digital signature. In embodiments this is based on the ECDSA using the elliptic curve secp256k1. A digital signature signs a particular piece of data. In embodiments, for a given transaction the signature will sign part of the transaction input, and all or part of the transaction output. The particular parts of the outputs it signs depends on the SIGHASH flag. The SIGHASH flag is a 4-byte code included at the end of a signature to select which outputs are signed (and thus fixed at the time of signing).

The locking script is sometimes called “scriptPubKey” referring to the fact that it comprises the public key of the party to whom the respective transaction is locked. The unlocking script is sometimes called “scriptSig” referring to the fact that it supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

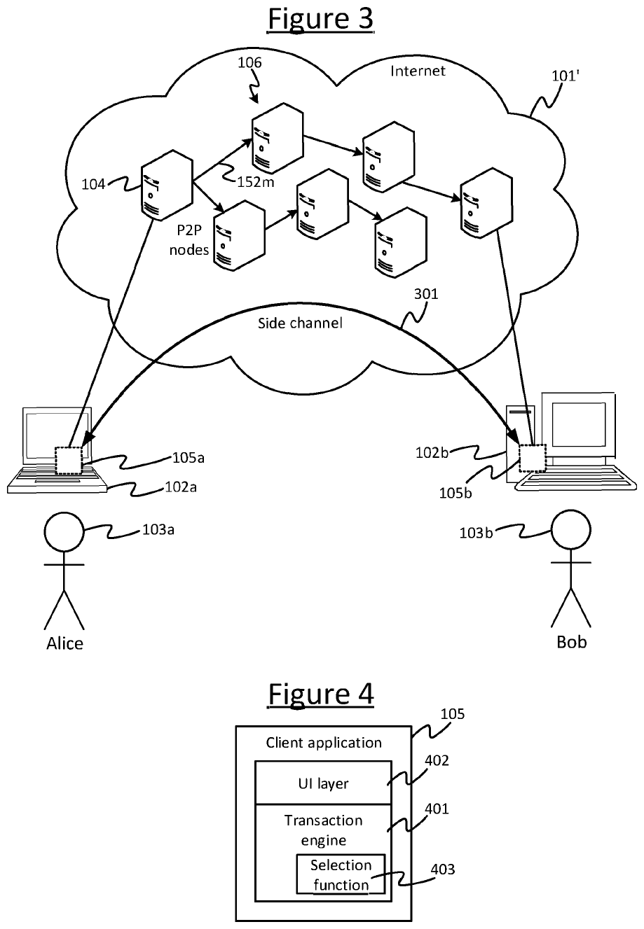

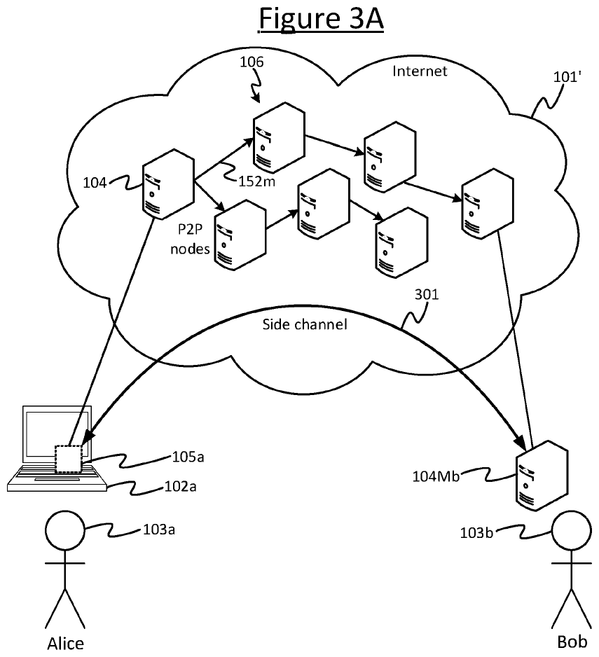

FIG. 3 shows a system 100 for implementing a blockchain 150. The system 100 is substantially the same as that described in relation to FIG. 1 except that additional communication functionality is involved. The client application on each of Alice and Bob's computer equipment 102a, 120b, respectively, comprises additional communication functionality. That is, it enables Alice 103a to establish a separate side channel 301 with Bob 103b (at the instigation of either party or a third party). The side channel 301 enables exchange of data separately from the P2P network. Such communication is sometimes referred to as “off-chain”. For instance this may be used to exchange a transaction 152 between Alice and Bob without the transaction (yet) being published onto the network P2P 106 or making its way onto the chain 150, until one of the parties chooses to broadcast it to the network 106. Such a side channel 301 is sometimes referred to as a “payment channel”.

The side channel 301 may be established via the same packet-switched network 101 as the P2P overlay network 106. Alternatively or additionally, the side channel 301 may be established via a different network such as a mobile cellular network, or a local area network such as a local wireless network, or even a direct wired or wireless link between Alice and Bob's devices 1021, 102b. Generally, the side channel 301 as referred to anywhere herein may comprise any one or more links via one or more networking technologies or communication media for exchanging data “off-chain”, i.e. separately from the P2P overlay network 106. Where more than one link is used, then the bundle or collection of off-chain links as a whole may be referred to as the side channel 301. Note therefore that if it is said that Alice and Bob exchange certain pieces of information or data, or such like, over the side channel 301, then this does not necessarily imply all these pieces of data have to be send over exactly the same link or even the same type of network.

FIG. 3A illustrates a variant of the arrangement shown in FIG. 3. In this variant Bob 103b is also a miner. His computer equipment, labelled here 104Mb, may be configured to operate as described in relation to both the user equipment 102b and a miner node 104M. It is arranged to run a client application 105b comprising a wallet application, and also run the miner software. The wallet and miner software could be integrated into the same application or implemented across two or more applications. Bob's equipment may take any of the forms discussed previously in relation to the user equipment 102b or miner equipment 104M. Such an arrangement may have an application where Alice wishes to specify a specific fee for Bob to mine a transaction 152 into a block 151 on her behalf, as will be discussed in more detail by way of example shortly. Note in fact that typically, most or all of the mining nodes 104M would in fact be associated with wallet applications 105 run by their operators, in order for them to be able to receive and spend mining fees. For simplicity this is not illustrated in the Figures since these miners are not involved as specific identified parties to the transactions in the following example use cases (they have no particular involvement other than that in some cases they could happen to be the miner who mines one of the transactions into a block 151).

### EXAMPLE DEFINITIONS

The following are some example definitions which may be adopted in some implementations. Note that these are not all limiting on all possible implementations and are provided only to aid understanding of certain possible implementations, such as may be employed in some possible implementations of the later-described example use cases.

Definition 1: Transaction. A transaction is a message that contains inputs and outputs. It may also comprise a protocol version number and/or a locktime. The version indicates the version of the transaction protocol. Locktime will be explained separately later.

Definition 2: Inputs. The inputs of a transaction form an ordered list. Each entry in the list comprises an outpoint (identifier for unspent transaction output), and scriptSig (unlocking script). It may also comprise a sequence number.

Definition 3: Outputs. The outputs of a transaction form an ordered list. Each entry in the list comprises a value (the amount of the digital asset in its fundamental units), and scriptPubKey (locking script).

Definition 4: Outpoint. An outpoint is uniquely defined by a transaction ID TxID and an index number i. It refers to the ith entry in the outputs of the transaction TxID, giving the unique location of an unspent transaction output (UTXO). The term ‘unspent’ here means that the outpoint has never appeared in any valid subsequent transaction.

Definition 5: scriptSig. This is the information required to unlock or to spend the UTXO corresponding to a given outpoint. In a standard transaction, this information is usually an ECDSA signature. Therefore, the script is called ‘scriptSig’. However, the required information to unlock the outpoint can be any data that satisfies the locking conditions of the UTXO.

Definition 6: scriptPubKey. This is a script that locks the fund associated with a particular UTXO. The funds are unlocked, and can be spent, if and only if a scriptSig is appended to a scriptPubKey and the execution of the combined script gives TRUE. If this is not the case, the transaction is invalid and will be rejected. It is called ‘scriptPubKey’ because it generally contains the hash value of an ECDSA public key for standard transactions.

In the next definition, where reference is made to signing an input or inputs, this means to sign an input or inputs excluding the scriptSig part (see Definition 2).

Definition 7: SIGHASH flag. When providing an ECDSA signature, one needs also to append one of the following SIGHASH flags.

| Flag | Functional meaning |
|---|---|
| SIGHASH_ALL | Sign all inputs and outputs |
| SIGHASH_SINGLE | Sign all inputs and the |
| | output with the same index |
| SIGHASH_NONE | Sign all inputs and no output |
| SIGHASH_ALL \| ANYONECANPAY | Sign its own input and |
| | all outputs |
| SIGHASH_SINGLE \| ANYONECANPAY | Sign its own input and the |
| | output with the same index |
| SIGHASH_NONE \| ANYONECANPAY | Sign its own input and no |
| | output |

When talking about malleability as a feature, one is looking for information in a transaction that is not signed by an ECDSA signature. Apart from inputs and outputs that could be excluded from the message to be signed, the content of the scriptSig is always excluded. This is because the scriptSig is designed to be the placeholder for the signature.

Definition 8: Blockchain time-locks. In general, there are two types of time-lock that can be used in transactions: absolute and relative time-locks. Absolute time-locks specify a specific point in time after which something can be considered ‘valid’ whereas relative time-locks specify a period that must elapse before something can be considered valid. In both cases, one can use either block height (number of blocks mined) or time elapsed (e.g. UNIX time) as the proxy for time when using blockchain time-locks.

Another property of blockchain time-locks is where they appear and to which aspect(s) of a transaction they apply. There are again, two classifications for time-locks in this sense: transaction-level, which lock entire transactions; and script-level, which lock specific outputs. Both of these time-lock levels can be used to implement either an absolute or relative time-lock. The table below summarises the four possible mechanisms for implementing time-locks that can be created based on these properties.

| | | Type | |
|---|---|---|---|
| | | Absolute | Relative |
| Level | Transaction | nLocktime | nSequence |
| | Level | | |
| | Script Level | OP_CLTV | OP_CSV |

Definition 9: nLocktime. The locktime (nLocktime) is a non-negative integer that represents the height of a block or a specific time in Unix time. It is a transaction-level time-lock in the sense that the transaction can only be added to the blockchain after the specified block or the specified time. If nLocktime is set to be less than 500,000,000, it is considered a block height. If it is set to be equal to or greater than 500,000,000, then it is considered as a representation of the Unix time. That is the number of seconds after 00:00:00 on the 1st January 1970.

For example, if the current highest block is of height 3,000,000, and the locktime is set to be 4,000,000, then the transaction will not be considered by miners until the 4 millionth block is mined.

Definition 10: nSequence. The sequence number (nSequence) indicates the version of the transaction as a message. Any modification on the transaction will increment the sequence number to a larger one. The maximum value of nSequence is 2³²−1 and, in general, the sequence number will be set to this maximum by default to indicate that the transaction is finalised. The nSequence value is defined for each input of a transaction and specifies the period of time after the UTXO referenced by the input was included in a block before it can be used as a valid input. If a miner sees two transactions with the same input, the miner will choose the transaction with the larger sequence number. However, this feature has been commonly disabled.

Definition 11: CheckLockTimeVerify (OP_CLTV). The opcode OP_CHECKLOCKTIMEVERIFY (OP_CLTV) is an absolute script-level time-lock that can be used to lock a specific output of a transaction to some specific time or block height in the future. If the current Unix time or block height, at which a UTXO is referenced in a transaction, is exceeded by the Unix time or block height at which the UTXO was created plus the parameter specified before the OP_CLTV opcode the script execution for the spending transaction will fail.

Definition 12: CheckSequenceVerify (OP_CSV). The opcode OP_CHECKSEQUENCEVERIFY (OP_CSV) is a relative script-level time-lock that can be used to lock a specific output of a transaction for a specific period of time or number of blocks into the future. This operates similarly to OP_CLTV, the difference being that the parameter provided to OP_CSV represents relative time. If the current Unix time or block height, at which a UTXO is referenced in a transaction, is exceeded by the parameter specified before the OP_CSV opcode the script execution for the spending transaction will fail.

Definition 13: Malleability. In general, there are two broad types of malleability that are possible in blockchain transactions, both of which allow the content of a transaction to be modified without invalidating the signature provided in an input.

To illustrate both cases, consider an initial transaction Tx which has one input, one signature in that input, and one output.

Type 1: Script-level malleability. This type of malleability takes advantage of the fact that a signature, which is to be checked with the script opcode OP_CHECKSIG, does not sign the script field of any input in a transaction. This fact allows us to generate a signature on a transaction Tx, modify the input script such that the transaction Tx′ is non-identical to Tx, and still have both Tx and Tx′ be considered valid transaction messages signed by the same signature under the blockchain consensus rules.

Type 2: Input and Output-level malleability. This type of malleability relies on the use of SIGHASH flags other than SIGHASH ALL being employed in a transaction. If a transaction Tx has an input signature that uses any of the five other SIGHASH flag combinations, then either an input(s) or output(s) can be added to create a non-identical transaction Tx′, such that both will be considered valid transaction messages according to the consensus, without needing to alter the signature.

### Negotiation Channel

FIG. 4 illustrates an example implementation of the client application 105 for implementing embodiments of the presently disclosed scheme. The client application 105 comprises a transaction engine 401 and a user interface (UI) layer 402. The transaction engine 401 is configured to implement the underlying transaction-related functionality of the client 105, such as to formulate transactions 152, receive and/or send transactions and/or other data over the side channel 301, and/or send transactions to be propagated through the P2P network 106, in accordance with the schemes discussed above and as discussed in further detail shortly. In accordance with embodiments disclosed herein, the transaction engine 401 of each client 105 comprises an application function 403 in the form of a selection function, which enables a selection as to which of two or more different instances of a first transaction (Tx₁₋ₜₑₘₚₗₐₜₑ, Tx₁, Tx₁′, etc.) to be offered or accepted in a negotiation over the side channel 301 between Alice and Bob. The selection function 403 may be configured such that accepting an instance of the transaction through the selection function 403 causes that instance to be broadcast to the network 106, i.e. sent from the respective computer equipment 102 to be propagated through the P2P network 106 for validation and thus recorded in the blockchain 150 (the propagation and recordal in themselves being by the mechanisms discussed previously). Note again that this sending could comprise sending the target transaction directly from the respective computer equipment 102 to one of the forwarding nodes 104F of the network 106, or sending the target transaction to the equipment 102 of the other party or that of a third party to be forwarded on from there to one of the nodes 104F of the network 106.

The UI layer 402 is configured to render a user interface via a user input/output (I/O) means of the respective user's computer equipment 102, including outputting information to the respective user 103 via a user output means of the equipment 102, and receiving inputs back from the respective user 103 via a user input means of the equipment 102. For example the user output means could comprise one or more display screens (touch or non-touch screen) for providing a visual output, one or more speakers for providing an audio output, and/or one or more haptic output devices for providing a tactile output, etc. The user input means could comprise for example the input array of one or more touch screens (the same or different as that/those used for the output means); one or more cursor-based devices such as mouse, trackpad or trackball; one or more microphones and speech or voice recognition algorithms for receiving a speech or vocal input; one or more gesture-based input devices for receiving the input in the form of manual or bodily gestures; or one or more mechanical buttons, switches or joysticks, etc.

Note: whilst the various functionality herein may be described as being integrated into the same client application 105, this is not necessarily limiting and instead they could be implemented in a suite of two or more distinct applications, e.g. one being a plug-in to the other or interfacing via an API (application programming interface). For instance, the functionality of the transaction engine 401 may be implemented in a separate application than the UI layer 402, or the functionality of a given module such as the transaction engine 401 could be split between more than one application. Nor is it excluded that some or all of the described functionality could be implemented at, say, the operating system layer. Where reference is made anywhere herein to a single or given application 105, or such like, it will be appreciated that this is just by way of example, and more generally the described functionality could be implemented in any form of software.

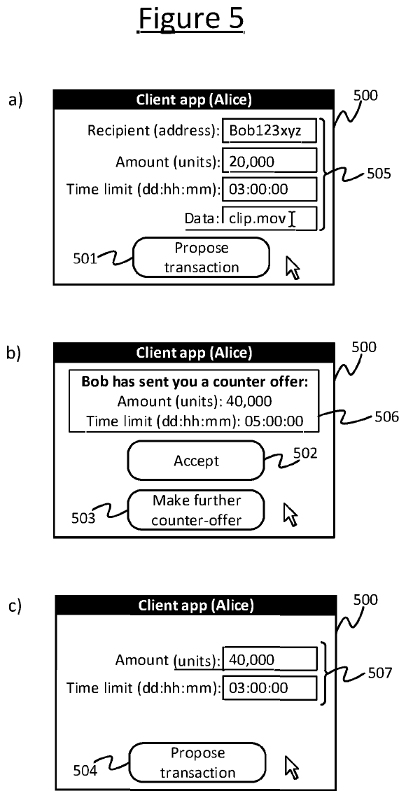

FIG. 5 gives a mock-up of an example of the user interface (UI) 500 which may be rendered by the UI layer 402 of the client application 105a on Alice's equipment 102a. It will be appreciated that a similar UI may be rendered by the client 105b on Bob's equipment 102b, or that of any other party.

By way of illustration FIG. 5 shows the UI 500 from Alice's perspective at three different stages a), b), c) of a negotiation procedure. Over the course of the procedure, the user interface 500 may render a plurality of user-selectable options, e.g. 501, 502, 503, 504, which may be rendered as distinct UI elements via the user output means, such as different on-screen buttons, or different options in a menu, or such like. The user input means is arranged to enable the user 103 (in this case Alice 103a) to select one of the options, such as by clicking or touching the UI element on-screen, or speaking a name of the desired option (N.B. the term “manual” as used herein is meant only to contrast against automatic, and does not necessarily limit to the use of the hand or hands). The options enable the user (Alice) to select to propose and accept transactions via the side channel 301, as will be discussed in more detail shortly. The user interface 500 may also comprise one or more data entry fields, e.g. 505, 507 presented at one or more stages, through which the user can enter details identifying another party (Bob) with whom to open negotiations, and/or enter parameters of one or more proposed transactions (such as the amount or lock time). These data entry fields are rendered via the user output means, e.g. on-screen, and the data can be entered into the fields through the user input means, e.g. a keyboard or touchscreen. Alternatively the data could be received orally for example based on speech recognition. The UI 500 may also render one or more notifications 506 presented through the user output means at one or more stages of the procedure. E.g. this/these could be rendered on screen or audibly.

It will be appreciated that the particular means of rendering the various UI elements, selecting the options and entering data is not material. The functionality of these UI elements will be discussed in more detail shortly. It will also be appreciated that the UI 500 shown in FIG. 5 is only a schematized mock-up and in practice it may comprise one or more further UI elements, which for conciseness are not illustrated.

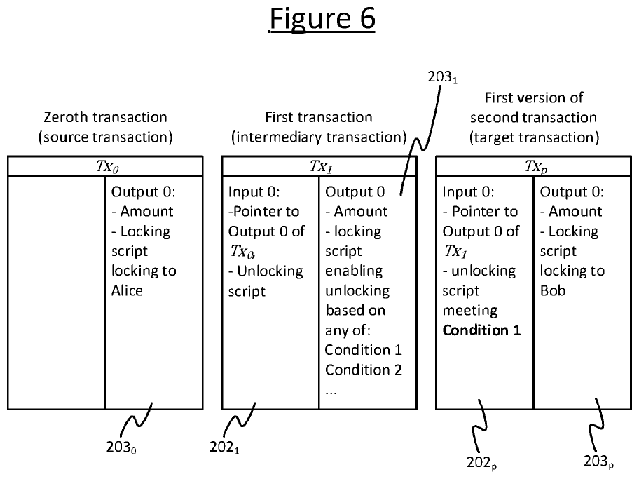

FIG. 6 illustrates a set of transactions 152 for use in accordance with embodiments disclosed herein. The set includes a zeroth transaction Tx₀, a first transaction Tx₁ and a second transaction Txₚ. Note that these names are just convenient labels. They do not necessarily imply that these transactions will be placed immediately one after another in a block 151 or the blockchain 150, nor that the zeroth transaction is the initial transaction in a block 151 or the blockchain 150. Nor do these labels necessarily imply anything about the order their transactions are sent to the network 106. They refer only to a logical series in that the output of one transaction is pointed to by the input of the next transaction. Remember that in some systems it may be possible to send a parent to the network 106 after its child (in which case the “orphan” child will be buffered for a period at one or more nodes 104 while waiting for the parent to arrive).

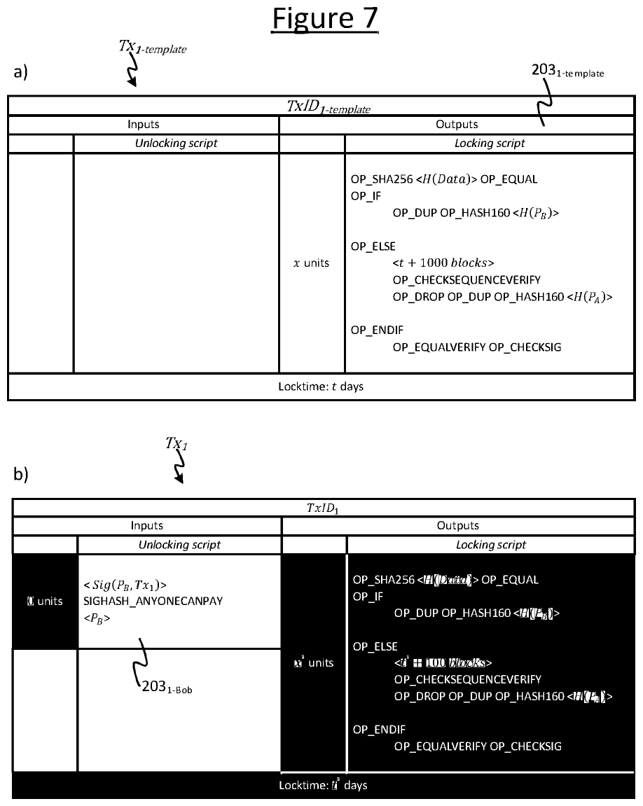

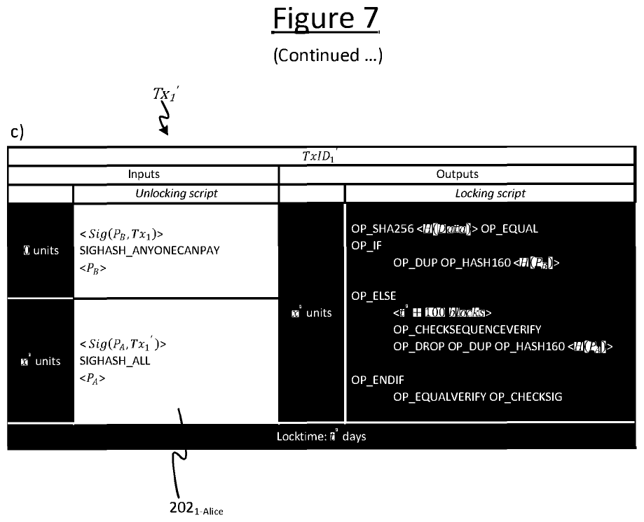

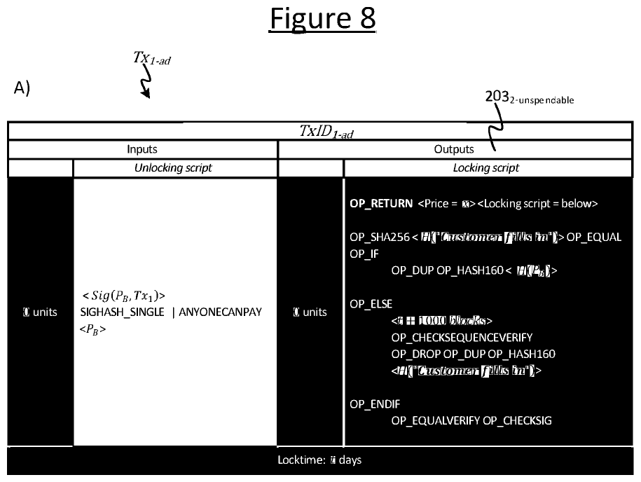

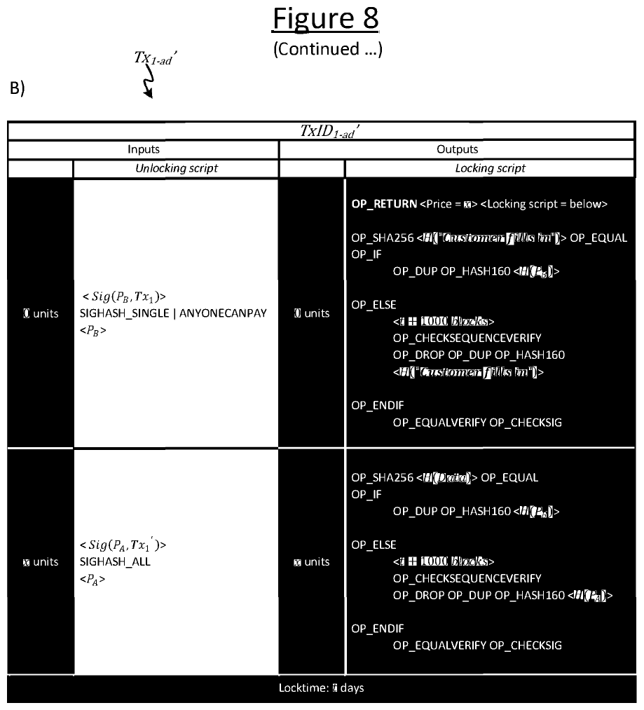

Embodiments may optionally enable different alternative versions of the second transaction Txₚ to be used. These may be said to be versions of (substantially) the same transaction if both contain an input that references the same output (e.g. same UTXO) of the first transaction. The different versions may provide different functionality by meeting a different unlocking condition of that output. The negotiation procedure, discussed shortly, will also involve two or more different instances of the first transaction Tx₁₋ₜₑₘₚₗₐₜₑ, Tx₁, Tx₁′, Tx₁″, etc. Two (or more) transactions may be said herein to be instances of (substantially) the same first transaction if both contain an input that references the same output (e.g. UTXO) of the same source transaction (or “zeroth” transaction) Tx₀. They may redeem that input based on meeting the same unlocking condition. The different instances may serve substantially the same function, but specifying different proposed and counter-proposed values of one or more transaction parameters (e.g. the amount of the digital asset and/or the locktime). This will be discussed in more detail later with reference to FIGS. 7 and 8.

The zeroth transaction Tx₀ may also be referred to as the source transaction for the present purposes, in that it acts as a source of an amount of the digital asset which is locked to Alice 103a. The first transaction Tx₁ may also be referred to as the intermediary transaction or conditional transaction for the present purposes, in that it acts as an intermediary for conditionally transferring the amount of digital asset from the source transaction Tx₀. The second transaction Txₚ may also be referred to as the target transaction, or payment transaction (hence the subscript “P”), as it is the transaction that will unlock one of the conditions and deliver the payment for Bob (or potentially a beneficiary on behalf of whom Bob is acting). In some embodiments, two alternative versions of the second or target transaction Txₚ may be possible, one which enables Bob to transfer an amount from the output of Tx₁ on meeting a condition such as including a specified data payload in an input of Txₚ, and another which enables Alice to claim back an amount from the output of Tx₁ if Bob has not claimed it after a period defined by a timelock in the output of Tx₁.

As shown in FIG. 6, the zeroth or source transaction Tx₀ comprises at least one output 203₀ (e.g. output 0 of Tx₀) which specifies an amount of the digital asset, and which further comprises a locking script locking this output to Alice 103a. This means that the locking script of the source transaction Tx₀ requires at least one condition to be met, which is that the input of any transaction attempting to unlock the output (and therefore redeem the amount of the digital asset) must include a cryptographic signature of Alice (i.e. using Alice's public key) in its unlocking script. In this sense the amount defined in the output of Tx₀ may be said to be owned by Alice. The output may be referred to as a UTXO. It is not particularly material for the present purposes which output of which preceding transaction the inputs of Tx₀ point back to (as long as they are sufficient to cover the total output(s) of Tx₀).

In the present case the transaction unlocking the output of the source transaction Tx₀ is an instance of the first, or intermediary, transaction Tx₁. Therefore the finalized instance of Tx₁ will have at least one input 202₁ (e.g. input 0 of Tx₁) which comprises a pointer to the relevant output of Tx₀ (output 0 of Tx₀ in the illustrated example), and which further comprises an unlocking script configured to unlock the pointed-to output of Tx₀ according to the condition defined in the locking script of that output, which requires at least a signature of Alice. The signature required from Alice by the locking script of Tx₀ is required to sign some part of Tx₁. In some protocols the part of Tx₁ that needs to be signed can be a setting defined in the unlocking script of Tx₁. E.g. this may be set by the SIGHASH flag, which is one byte that is appended to the signature, so in terms of data the unlocking script appears as: <Sig P_{A}><sighashflag><P_{A}>. Alternatively the part that needs to be signed could simply be a fixed part of Tx₁. Either way, the part to be signed typically excludes the unlocking script itself, and may exclude some or all of the inputs of Tx₁. This means the inputs of Tx₁ are malleable.

The first or intermediary transaction Tx₁ has at least one output 203₁ (e.g. output 0 of Tx₁ which again the output may be referred to as a UTXO). Optionally, in embodiments, the output of the intermediary transaction Tx₁ is not locked unconditionally to any one party. Like Tx₀ it has at least one output (e.g. output 0 of Tx₁) which specifies an amount of digital asset to be transferred onwards, and which further comprises a locking script defining what is required to unlock that output and hence redeem this amount. However, in some embodiments, this locking script allows its output to be unlocked based on any one of multiple different possible conditions, including at least: i) a first condition (“Condition 1”) and ii) a second condition (“Condition 2”).

The second, target transaction Txₚ has at least one input 202p (e.g. input 0 of Txₚ) which comprises a pointer to the above-mentioned output of Tx₁ (output 0 of Tx₁ in the example shown), and which also comprises an unlocking script configured to unlock said output of Tx₁ based on meeting one of the one or more conditions defined in the locking script of Tx₁. In a first version of the target transaction Txₚ, the unlocking script is configured to meet the first condition, Condition 1. Alternatively in a second version of the target transaction, the unlocking script may be configured to meet the second condition, Condition 2.

The second, target transaction Txₚ has at least one output 203p (e.g. output 0 of Txₚ) which, in the first version specifies an amount of the digital asset to transfer to Bob, or in the second version specifies an amount to transfer back to Alice. The output 203p also comprises a locking script locking this to Bob or Alice respectively (i.e. it would require a further, onward transaction including Bob's or Alice's signature, respectively, in the unlocking script to spend). In this sense the output of the target transaction Txₚ can be said to be owned by Bob or Alice, depending on whether the first or second version is used respectively. This output may again be referred to as a UTXO.

In embodiments the first condition requires that the unlocking script of whichever transaction is attempting to unlock Tx₁—in this case the first version of the target transaction Txₚ—includes in its unlocking script a cryptographic signature of Bob, and/or a data payload which may be data of Bob which Bob will have to provide or include. The requirement to include the data payload can be imposed by a hash challenge included in the locking script of Tx₁. The challenge comprises a hash of the data (not the data itself), along with a piece of script configured so as (when run on a node 104 together with the unlocking script) to test whether a hash of the data provided in the corresponding unlocking script equals the hash value provided in the locking script. The requirement for a signature can be imposed for example by the CheckSig discussed previously. In embodiments the first condition does not require Alice's signature to be included in the unlocking script of Txₚ. The part of Txₚ that needs to be signed by Bob may be a setting of the unlocking script of Txₚ (e.g. specified by the SIGHASH flag), or could be fixed. Either way, it excludes at least the unlocking script.

In embodiments the second condition, ii) Condition 2, requires that the unlocking script of whichever transaction is attempting to unlock Tx₁—in this case the second version of the target transaction Txₚ—includes in its unlocking script a cryptographic signature of Alice (but in embodiments not Bob). It also requires that a locktime has expired. This enables Alice to claim back her payment from the output of Tx₁ (in practice less a mining fee) if Bob does not claim it based on the first condition, i) condition 1. E.g. this could occur either because Bob does not engage in the process at all, or because he fails to mine the first version of Txₚ into a bock 151 within the period specified by the locktime. This locktime may be defined as an absolute point in time, or a period of time to be elapsed. It may be specified and measured in human time (e.g. seconds, minutes, hours or days) or in terms of number of blocks mined.

The zeroth (i.e. source) transaction Tx₀ may be generated by Alice, Bob or a third party. It will typically require the signature of the preceding party from whom Alice obtained the amount defined in the input of Tx₀. It may be sent to the network 106 to be mined by Alice, Bob, the preceding party, or another third party. In another alternative, if Bob is a miner 104Mb, then the source transaction Tx₀ does not need to be broadcast to the network 106 and instead Bob could mine it himself.

An instance of the first (i.e. intermediary, conditional) transaction Tx₁ may also be generated by Alice, Bob or a third party. Since in embodiments it requires Alice's signature, it may be generated by Alice. Alternatively it may be generated by Bob or a third party as a template then sent to Alice to sign, e.g. being sent over the side channel 301. Alice can then send the signed transaction to the network 106 herself, or send it to Bob or a third party for them to forward to the network 106, or just send her signature for Bob or the third party to assemble into the signed, finalized instance of Tx₁ and forward to the network 106. Again any off-chain exchanges prior to sending the finalized instance of Tx₁ to the network 106 may be performed over the side channel 301. In another alternative, if Bob is a miner 104Mb, then the first transaction Tx₁ does not need to be broadcast to the network 106 and instead Bob could mine it himself.

Either version of the second (i.e. target or payment) transaction Txₚ may be generated by Alice, Bob or a third party. As the first version requires Bob's signature and/or data, it may be generated by Bob. Alternatively it may be generated as a template by Alice or a third party then sent to Bob to sign and add the data, e.g. being sent to Bob over the side channel 301. In embodiments Bob is a miner 104Mb being paid by Alice to mine the second transaction Txₚ (including her data payload) into a block 151. In this case the second transaction Txₚ does not need to be broadcast to the network 106 and instead Bob could mine it himself. Alternatively however, if Txₚ is paying Bob for some other service, then it could either be mined by Bob himself (if he is a miner) or broadcast to the network 106 for mining by some other party (whether Bob is a miner or not). In the latter case, Bob may send the signed transaction to the network 106 himself, or send it to Alice or a third party for them to forward to the network 106, or just send his signature and data for Alice or the third party to assemble into the signed Txₚ and forward to the network 106. In embodiments the second version requires the signature of Alice. Hence it may be generated by Alice, or generated as a template by Bob and sent to Alice as a template to add their part, e.g. again over the side channel 301. Alternatively it could be generated as a template by a third party and then sent to Alice, where Alice adds her signature and forwards to Bob or a third party for them to forward to the network 106. Again any off-chain exchanges prior to sending Txₚ to the network 106 may be performed over the side channel 301.

It will be appreciated that there are various locations at which the different elements of a transaction can be generated and assembled, and various ways for it to be sent onwards directly or vicariously to the ultimate destination of the P2P network 106. The scope of implementation of the disclosed techniques is not limited in any of these respects.

It will also be appreciated that phrases such as “by Alice”, “by Bob” and “by a third party” herein may be used as a short-hand for “by the computer equipment 102a of Alice 103a”, “by the computer equipment 102b of Bob 103b”, and “by computer equipment of the third party”, respectively. Also, note again that the equipment of a given party could comprise one or more user devices used by that party, or server resources such as cloud resources employed by that party, or any combination of these. It does not necessarily limit the actions to being performed on a single user device or at a single physical location.

According to embodiments disclosed herein, Alice negotiates a fee with Bob in advance, for Bob to mine a transaction (Txₚ) which will store some (potentially large) item of data in the blockchain 150. E.g. this data could comprise a document comprising text, or a still image, or an audio or video clip. Negotiating the fee in advance saves on network congestion since otherwise, in order to get the best deal, Alice would have to begin by publishing one instance of the first transaction Tx₁ over the network 106 generally, offering a small mining fee, and see if any miner 104M “bites”; and then if not, she would need to increment the fee slightly and try again, and so forth (or otherwise Alice may just end up offering too much to begin with). This could lead to a large number of ineffectual transactions being published over the P2P network by Alice 106. Whereas if the parameters of the transaction (e.g. data, amount and lock time) are agreed in advance with a particular miner Bob 103b, then only the agreed instance of the first transaction Tx₁ needs to be published to the network 106 (as well as Tx₀ and Txₚ of course).

The present disclosure provides a scheme whereby this saving on network congestion is achieved by exchanging a series of template or proposed instances of the first transaction Tx₁₋ₜₑₘₚₗₐₜₑ, Tx₁, Tx₁′, Tx₁″, . . . over the side channel 301, using the same transaction protocol as is recognized by the P2P network 106. Because the proposals and counter-proposals are exchanged over the side channel 301 in the form of actual transactions including proposed parameters of the transaction, this enables Alice and Bob to conduct the exchange regardless of whether Alice and Bob's clients 105a, 105b are of the same type, i.e. without requiring them to share a common bespoke messaging protocol for making proposals and counter-proposals over the side channel 301. This enables the saving on network congestion in a way that also avoids a potential interoperability issue that might otherwise occur. Alice and Bob may happen to run the same type of client 105 or may not, but either way, they do not have to coordinate or guarantee in advance that they do so. In embodiments, the proposed instances of the first transaction Tx₁ may be the only messages exchanged between Alice and Bob over the side channel 301 as part of the negotiation. Alternatively it is not excluded that there is some non-essential signalling overlaid on this over the side channel 301, or some supporting communication via some other standardized mechanism, for example.

An example of the procedure is now described in more detail with respect to FIG. 5. Some corresponding example transaction formats are shown in FIG. 7. The procedure may be implemented through the selection function 403 and surfaced to Alice and Bob through the user interface 500 of their respective client applications 105.

At a first stage a) in the procedure, Alice enters proposed values of one or more parameters for the first transaction Tx₁ into one or more data entry fields 505 of her client application 105a. This will include at least an amount of the digital asset she wishes to initially offer Bob to mine an item of data (the data payload) into a block 151 so as to record it in the blockchain 150. Optionally she may also enter one or more other values of one or more other respective parameters to be proposed for inclusion in the first transaction Tx₁ such as a locktime. Note that while the term “locktime” may have a specific definition in some example transaction protocols or scripting languages, nonetheless as referred to herein, the term locktime may more generally refer to any parameter for specifying a period that must lapse before a particular condition of the unlocking script of Tx₁ can be unlocked. It could be measured in human time (seconds, minutes, hours and/or days, etc.) or in some other terms, such as a number of transactions or blocks mined after a certain defined point (e.g. running from the point at which the finalized instance of Tx₁ is mined into a block 151). More generally still, one or more other, alternative or additional parameters could be imposed as criteria of a given unlocking condition by the locking script. The scripting language may enable almost limitless possibilities for user-defined criteria to be specified as part of an unlocking condition, which may be parameterized by one or more parameters, and the value(s) of any one more such parameters could form part of the proposal to Bob.

Alice also enters into one of the data entry fields 505 an indication of the item of data she wishes to have recorded, e.g. by selecting a file such as a text file, word processing document file, database file, spreadsheet file, audio file or video file. Furthermore, Alice also enters into one of the data entry fields 105 an indication of the user she wishes to make the proposal to, in this case Bob. E.g. this could comprise an address of Bob within the transaction protocol being used, or a username of Bob which Alice's client 105a converts into an address. More generally the indication of Bob may comprise any means of uniquely indicating Bob or contacting Bob over the side channel 301. The side channel 301 may already be established at this point, or this could be the means of establishing the channel 301.

Alice's client 105a automatically composes the information provided by Alice into a template transaction, which is a first instance of the first transaction Tx₁₋ₜₑₘₚₗₐₜₑ. An example is shown in FIG. 7.

After entering the data, Alice actuates a “propose transaction” option 501 in the UI 500 of her client 105a. In response, the client 105a sends the template transaction Tx₁₋ₜₑₘₚₗₐₜₑ to Bob's client 105b over the side channel 301 (also termed herein the “negotiation channel”). In embodiments, the client 105a formulates the template transaction Tx₁₋ₜₑₘₚₗₐₜₑ in response to Alice actuating the “propose transaction” option 501 and then sends it to Bob. Alternatively, the client 105a could formulate it in anticipation of Alice actuating the “propose transaction” option 501, after Alice enters her proposed parameter values or even formulating it piece-by-piece, as-and-when Alice enters respective parameters.

As shown in FIG. 7, at this stage a) the template transaction Tx₁₋ₜₑₘₚₗₐₜₑ formulated by Alice's client 105a may comprise no inputs. It does however comprise an output 203₁₋ₜₑₘₚₗₐₜₑ containing the proposed parameters. This output 203₁₋ₜₑₘₚₗₐₜₑ comprises the proposed amount x and a locking script defining at least one condition for redeeming this amount.

If Alice provided an input from the beginning, including valid signature, this initial template Tx₁₋ₜₑₘₚₗₐₜₑ would be a valid transaction and could be mined. This would means that Bob could mine without negotiating at all, so it may be desirable that Alice does not include an input at this stage. If she were to include an input, she could still ensure the transaction is still invalid overall to avoid the above effect. For example, this could be by including an input too small in value to cover the output (e.g. half of the output value as an ‘up front’ commitment to payment), but this is just more complex than including no input and wouldn't necessarily provide any real benefit. Alternatively, if Alice is happy for Bob to have the option to mine her first proposal, she could include an input and make Tx₁₋ₜₑₘₚₗₐₜₑ valid from the start.

In embodiments the unlocking script of each instance of Tx₁ defines two alternative conditions for redeeming the output: i) a first condition requiring Bob to include his signature and the data payload in the unlocking script of an input of Txₚ (this being the first possible version of Txₚ); and ii) a second, alternative condition requiring a locktime t to have expired and Alice to include her signature in the unlocking script of an input of Txₚ (this being the second possible version of Txₚ). The first condition may be imposed by including a hash challenge comprising the hash of the data payload in the locking script, as discussed previously. The second condition enables Alice to claim x back if Bob does not mine the first version of the second transaction Txₚ into a block 151 by the time the locktime t expires. The locktime t may be one or the parameters of the transaction to be negotiated.

Note that at this stage, the template instance of the first transaction Tx₁₋ₜₑₘₚₗₐₜₑ is not a complete transaction, because the total of its outputs specify a greater amount of the digital asset than the total of its inputs, and also because it has no input that points to the output of Tx₀ and includes Alice's signature. Therefore this instance of the first transaction Tx₁₋ₜₑₘₚₗₐₜₑ would be deemed invalid if broadcast to the network 106 in this form. Nonetheless, the template instance of the first transaction Tx₁₋ₜₑₘₚₗₐₜₑ may be said herein to be formulated in accordance with the transaction protocol applied by the nodes 104 in that, so far as it is complete, the complete part complies with the protocol.

An advantage of Alice's first gambit being an invalid template transaction is that, because Alice's transaction is an invalid template at the point she gives it to Bob, Bob cannot simply unilaterally accept Alice's opening gambit without any further negotiation (whereas f Alice sent a complete transaction, then Bob could accept it without requiring confirmation from Alice). This may be beneficial due to that the fact that Alice and Bob can trade-off between multiple parameters in the transaction, so Bob may be able to give her a favourable counter offer. For example, if Alice's opening gambit says “I'm willing to pay 10 BSV if you mine within 6 days”, Bob have insufficient hash power to confidently claim he can meet the 6 day demand, and he may express a counter-offer saying “I'm willing mine within 10 days for a heavily discounted price of 3 BSV”. So Alice may still be inclined to accept Bob's counter offer because it is preferential for a different reason i.e. upon receiving the counter-offer Alice weighs up the two parameters of time and price and can conclude that she does not mind waiting an extra three days for that price. Having more than one parameter means that Alice and Bob will always potentially prefer a counter-offer that is not the same as their initial preference.

In alternative embodiments however, Alice could just include a complete input in the first instance of the first transaction Tx₁₋ₜₑₘₚₗₐₜₑ, by including her signature and a pointer to Tx₀. This would allow Bob to simply accept straight away if Alice's terms were acceptable, by sending off Tx₁₋ₜₑₘₚₗₐₜₑ to be propagated through the network 106 and thus recorded in the blockchain 150, and also adding his signature and the data to Txₚ and sending this off to be propagated through the network 106 and recorded in the chain 150.

Either way, in some embodiments an input of Tx₁₋ₜₑₘₚₗₐₜₑ may be used as a medium or carrier to convey the data payload to Bob over the side channel in the body of the template transaction Tx₁₋ₜₑₘₚₗₐₜₑ. This technique is based on the principle of malleability. This input is not shown in FIG. 7 but will be discussed in more detail later. It could be the same input that points to the output of Tx₀ and includes Alice's signature, or a separate input such as a null or redundant input. However this feature is not essential. Alternatively the data payload could simply be some data that Bob has already at his end, or that Alice communicates to Bob separable via some other, mutually recognized medium such as email, FTP (file transfer protocol), MMS (Multimedia Messaging Service), etc.

The process may proceed to a second stage b). Here Bob chooses whether to accept Alice's template or not, and if not Alice receives back a counter-proposal from Bob.

If Alice had included a complete input such that Tx₁₋ₜₑₘₚₗₐₜₑ was actually a valid transaction, then if Bob wished to accept he could do so simply by sending off Tx₁₋ₜₑₘₚₗₐₜₑ and Txₚ to be published to the network 106. However assuming Alice did not do this then Tx₁₋ₜₑₘₚₗₐₜₑ as this is not a complete, valid transaction. Assuming that is the case, and/or Bob does not wish to accept, then Bob will send back another, updated instance Tx₁ of the first transaction back to Alice over the side channel 301. Bob bases this on the template Tx₁₋ₜₑₘₚₗₐₜₑ provided by Alice.

In embodiments Bob is required to sign an instance of the first transaction Tx₁ and include his signature in an input 202_{a-Bob} of Tx₁. This could be a “zero value” input (in practice it would realistically be a negligibly small value). Bob's ‘0 unit’ input would point back to some source UTXO owned by Bob, in the same way that Alice's input 202_{a-Alice} (described shortly) points to a source UTXO she owns.

The intention with Bob adding such a zero-value input is to give him a way of signing to indicate his agreement to the outputs of the negotiation transaction (Tx₁) that will be validated by mining nodes on the network. The paradigm here is that the outputs of the template transaction Tx₁₋ₜₑₘₚₗₐₜₑ act as the customer's offer for Bob's service and Bob signing these preferences can be interpreted as him agreeing to offering a service under those conditions. However it is not essential that Bob has to add a small value input like this—alternative he could for example sign the template transaction (Tx₁₋ₜₑₘₚₗₐₜₑ) as a message and send that to Alice. She could include that signature in her payment input in Tx₁′ as (see later), or as another alternative Bob may simply not be required to sign at all.

The optional advantage of Bob actually including an input to Tx₁ (as show in FIG. 7) is that Bob's signature must be valid and checked by miners, which in a sense is a stronger representation of Bob's agreement to Alice's preferences—a bit like an on-chain contract ‘secured’ by the network.

If Bob wishes to accept Alice's offer, he forms Tx₁ simply by signing Tx₁₋ₜₑₘₚₗₐₜₑ. The parts to be signed by Bob are shown in black in stage b) of FIG. 7. Assuming Alice did not originally include her input, he then returns it to Alice via the side channel 301, and Alice then finalises the transaction (and negotiation) by signing Tx₁ to form Tx₁′. She then publishes this to the network 106 (directly or via a third party), or sends it back to Bob for him to mine or publish.

If Bob instead wishes to make a counter-proposal, he also modifies at least one of the transaction parameters before signing. This could for example comprise modifying the amount x of digital asset specified, or modifying the locktime t (effectively the time given to Bob to mine the data into a block 151), or both. Either way, Bob sends this modified instance Tx₁ of the first transaction (modified relative to the template) back to Alice over the side channel 301. In the case where he has modified one or more of the parameters, this acts as a counter-proposal to Alice.

Bob's counter offer may be rendered to Alice in a notification 506 in her client application 105a. If Alice wishes to accept the counter-proposal, then at stage c) she can simply add an input 202_{1-Alice} to Tx₁ including her signature and the pointer to the output of Tx₀, thus creating a further updated instance Tx₁′ of the first transaction (without making it a further counter-proposal from Alice). The part to be signed by Alice is shown black in stage c) of FIG. 7. In one embodiment, she then returns Tx₁′ to Bob and Bob then sends off both Tx₁′ and Txₚ to be propagated over the network 106 and recorded in the blockchain 150. In an alternative embodiment Bob could send Txₚ to Alice along with Tx₁′, and Alice then sends off Tx₁″ and Txₚ to be propagated over the network 106 and recorded in the chain 150. In another alternative, Alice sends off Tx₁′ to be propagated over the network 106, and signals acceptance to Bob via some other mechanism, and Bob sends off Txₚ to be propagated. Whichever embodiment is used, the client 105a may be configured to trigger the relevant actions in response to Alice actuating an “accept counter-proposal” control 502 in the UI of her client 105a.

In embodiments where Bob does not include his signature in an input 202_{a-Bob} of Tx₁ but instead sends it separately to Alice, then Alice could include that signature in her payment input 202_{1-Alice} in Tx₁′, e.g. as follows:

<Sig(P_{A}, Tx₁)>

SIGHASH_ALL

<P_{A}>

<Sig(P_{B}, Tx₁₋ₜₑₘₚₗₐₜₑ)> <—this is because Bob is now signing Tx₁₋ₜₑₘₚₗₐₜₑ rather than Tx₁

OP_DROP <—makes sure it is included in Alice's input script but not validated by miners

If Alice on the other hand Alice does not wish to accept Bob's counter offer, but wishes to continue negotiating, she instead actuates a “make further counter-offer” option 503 in the UI 500 of her client application 105a.

Here the UI 500 in Alice's client 105a prompts Alice with the opportunity to enter a further modified value of at least one of the one or more transaction parameters, through data entry fields 507 rendered through the UI 500 in her client 105a. This could again include for example a modified value of the amount x and/or locktime t. Once she has done this, she actuates another instance of the “propose transaction” control 504. In response, Alice's client 105a creates a further modified instance of the first transaction by updating the modified parameter value(s) in accordance with what Alice entered in the data entry fields 507, and by adding an input 202_{1-Alice} which includes Alice's signature and points to the output of the source transaction Tx₀. Note that because Tx₁ and Tx₁′ are both signed by Bob, the act of Alice making a counter-offer would actually be the same as her proposing a new instance of Tx₁₋ₜₑₘₚₗₐₜₑ; let's call it Tx₁₋ₜₑₘₚₗₐₜₑ′. The client then sends this further modified instance Tx₁₋ₜₑₘₚₗₐₜₑ′ to Bob over the side channel 301. Alternatively the client 105a can already start formulating Tx₁′ in advance of Alice actuating the “propose transaction” control 507, and then sends it to Bob triggered by the actuation of this control 507. The process then repeats from stage a). The process may repeated one or more times, each time starting at stage a) with the most recently proposed instance of the template transaction.

Once a complete, valid and acceptable instance of the first transaction Tx₁′ is agreed, then Bob or Alice send this off to be propagated and recorded in the blockchain 150. Alternatively Bob mines Tx₁′ into a block 151 himself. Either way, Bob also mines the first version of the second transaction Txₚ into a block 151, which results in the data payload being recorded in the blockchain 150.

Optionally Bob may signal his acceptance to Alice. E.g. this could be done by sending back the same instance of Tx₁′ to Alice over the side channel 301. As it is identical to Alice's proposed version, Alice's client 105a interprets this as an acceptance and notifies this to Alice though the UI 500 in her client 105a. Alternatively it is not excluded that Bob could send Alice a separate acceptance signal over the side channel 301, not formulated as a transaction. This would break the transaction-only signalling, but since this signal is non-essential, this could be considered acceptable. In another variant, Bob sends Tx₁′ back to

Alice over the side channel and Alice sends this off to be propagated over the network 106 and recorded in the blockchain 150.

If there is no mechanism for Bob to acknowledge, then Alice could deem the lack of a further counter-proposal from Bob as an implicit acceptance, or could simply wait to observe that her data has been included in the blockchain 150 in a transaction Txₚ pointing to the latest instance of the first transaction Tx₁′ As yet another possibility, it may be possible for Alice to query a given miner 104M to see if they have ‘accepted’ a transaction into their local copy of the mempool 154 before it is mined. APIs to query miners are possible though not implemented yet, so it is conceivable that Alice could get acknowledgement before seeing it on-chain.

In embodiments, Alice may be the one to initiate the negotiation, by performing a) and thus sending the proposed transaction Tx₁₋ₜₑₘₚₗₐₜₑ to Bob. Alternatively Bob could be the one to initiate the negotiation. In this case, prior to the first stage a), in a preliminary stage A) Bob sends an advertisement transaction to Alice over the side channel 301, or makes it available in a public service registry from which Alice retrieves the advertisement transaction.

An example is shown in FIG. 8A. The advertisement transaction comprises a suggested script with some suggested parameters for the first transaction. The suggested script is included in an unspendable output 203_{2-unspendable}, as specified by the opcode OP_Return in the example shown. This acts as an invitation to Alice to either accept the advertised terms or make a proposal to Bob. If she wishes Alice can simply accept the advertised terms by formulating an instance of the first transaction with the suggested script and parameter value(s). An example of this is illustrated in FIG. 8B. However if Alice does not accept but instead wishes to enter negotiations with Bob, she continues the process from the first stage a) as discussed in relation to FIGS. 5 and 7. One or more of the parameters entered by Alice in stage a) may differ from those initially suggested by Bob in the advertisement transaction in preliminary stage A).

Thus there has been disclosed a mechanism of using template transactions to allow Alice (a user) and Bob (a miner and service-provider) to negotiate the terms of a pay-to-upload operation, using a mining service that Bob offers.

Bob accepts Alice's offer by signing Tx₁₋ₜₑₘₚₗₐₜₑ to form Tx₁. Alice then finalises the transaction (and negotiation) by signing Tx₁ to form Tx₁′.

If Alice initiates, the transactions may be considered to represent the following:
a) Tx₁₋ₜₑₘₚₗₐₜₑ=Alice bringing an offer to the table,
b) Tx₁=Bob signing off agreeing to that offer, and
c) Tx₁′=Alice signing off to complete the (bi-lateral) agreement.

If Alice initiates the transactions basically represent the following:
a) Tx₁₋ₜₑₘₚₗₐₜₑ=Alice bringing an offer to the table
b) Tx₁=Bob signing off agreeing to that offer
c) Tx₁′=Alice signing off to complete the (bi-lateral) agreement

If Bob initiates, then we have the following:
A) Tx_{1-ad}=Bob advertising his services, he has already signed on these conditions at this point; then either
B) Tx_{1-ad}′=Alice agrees to complete the offer as set out and signed by Bob; or restart at stage a) of ‘Alice initiates’ and proceed as a)-c) above.

Conventionally, a payment channel is only used to send a complete, valid transaction between parties off-chain. In the present case on the other hand, for Alice initiating (case 1), Tx₁₋ₜₑₘₚₗₐₜₑ and Tx₁ are incomplete and invalid but exchanged off-chain nonetheless. When Bob initiates (case 2), either only Bob's advert is sent off-chain or a case 1 situation arises. In the presently disclosed system, Alice and Bob are negotiating the state of an incomplete transaction, to be signed at the end. In normal payment channels, the state of a complete transaction is being negotiated. In fact, in the negotiation channel, in some scenarios there may never be need for a complete, valid transaction to be sent off-chain (as occurs with normal payment channels).

As mentioned, there are two general cases to consider: Case 1, Alice instigates negotiation; and Case 2, Bob instigates negotiation (i.e. advertises his services). Examples of these are recapped below with reference to FIGS. 7 and 8.

### Case 1: Alice Initiates Negotiation

Step 1: Alice generates an incomplete, template transaction, and sends to Bob.

FIG. 7a) shows an example of the template transaction Tx₁₋ₜₑₘₚₗₐₜₑ, sent by Alice to Bob.

Step 2: Bob completes the template and thereby creates a negotiation transaction by adding input and signing. This is still invalid due to value of outputs>value of inputs. Note that Bob may also choose to update Alice's parameters x and t, which is deemed part of this negotiation phase.

FIG. 7b) shows an example of signed negotiation transaction Tx₁ sent from Bob to Alice. The data comprising the message signed by Bob's signature is highlighted in black.

Steps 1 and 2 are repeated as many times as necessary as negotiation rounds. Alice may propose as many offers to Bob as she deems necessary.

Step 3: When Alice receives a counter-offer/accepted offer from Bob, she adds her input and signs the entire transaction. This creates a malleated version Tx₁′ of the offer transaction Tx₁. The malleated form Tx₁′ is valid and Bob will mine. He will then also upload Alice's data D by mining a subsequent transaction Txₚ claiming the output of Tx₁′.

FIG. 7c) shows the signed, and malleated, negotiation transaction Tx₁′ sent from Alice to Bob. The data comprising the message signed by Alice's signature is highlighted in black.

Case 2: Bob initiates negotiation

Step 1: Bob advertises his ‘pay-for-upload’ service publicly. He does this by posting the following invalid transaction somewhere visible. The transaction encodes enough information for a customer to interpret and respond without contacting Bob directly. This could be done by Alice filling in the relevant fields in the OP_RETURN.

FIG. 8A) shows an example of the signed advertisement transaction Tx_{1-ad} sent from Bob to Alice. The data comprising the message signed by Bob's signature is highlighted in black.

Step 2: Alice can either (I) negotiate for a different price and upload time by sending Bob alternative transaction templates for him to sign; or (II) sign this transaction Tx_{1-ad} and complete the purchase of Bob's upload service. If Alice chooses (I) then the procedure has degenerated back to the negotiations of Case 1. Alternatively, if Alice is happy with Bob's advertised parameters then she signs to create the malleated transaction Tx_{1-ad}′. Note that this transaction takes advantage of a different SIGHASH flash to malleate the transaction. Bob's chosen flag allows Alice to add both an input and an output, without invalidating Bob's original signature.

FIG. 8B) shows an example of the signed, and malleated, negotiation transaction Tx_{1-ad}′ sent from Alice to Bob. The data comprising the message signed by Alice's signature is highlighted in black.

### Using Malleability to Convey Data

The following describes an optional additional technique which exploits the phenomenon of input-level malleability to use the template proposed transaction Tx₁₋ₜₑₘₚₗₐₜₑ (or Tx₁′ etc.) as a medium to convey the data payload to Bob over the side channel 301 in the body of the template transaction. Bob (or Alice or a third party) will then malleate the data payload out of Tx₁₋ₜₑₘₚₗₐₜₑ before it is sent to be propagated over the network 106 (and the data payload will instead be included in an input of the second transaction Txₚ assuming Bob at some stage accepts one of the proposals).

Malleability is an existing concept in cryptography that underpins a security concern whereby a message can be maliciously modified but still accepted as genuine. Digital signature schemes are designed to address this concern. In context of a blockchain, however, malleability refers to the ability to modify part of a transaction without invalidating the transaction as a whole. Any information in the transaction that is signed by a cryptographic signature (e.g. an ECDSA signature) is not subject to the possibility of malleation. Any security concern related to malleability would instead be caused by inappropriate implementation rather than the protocol itself. In embodiments, malleability may in fact be exploited as a useful feature to facilitate the communication of data in the body of a template transaction.

Consider the scenario already discussed whereby Alice is willing to pay a second actor to put a large amount of plain data or encrypted data on the blockchain. However, she is worried that no miner would accept her transaction at a fair price. To mitigate her concern, she contacts her miner friend Bob and promises him to pay a mutually agreed number of bitcoins. To make sure that Alice's data is published on the blockchain and Bob gets the payment, embodiments may employ the following technique.

As discussed, Alice negotiates a fee with Bob in advance, for Bob to mine a transaction Txₚ which will store some large item of data of Alice's in the blockchain 150. This saves on network congestion, since otherwise, in order to get the best deal, Alice would have to publish one transaction with a small fee over the network generally and see if anyone bites, then if not increment the fee slightly and try again, and so forth (or otherwise Alice may just end up offering too much.)

To facilitate interoperability, the negotiation is conducted by exchanging proposed instances of a first transaction Tx₁ over a side channel 301.

To exploit the malleability idea, the data payload D which Alice wishes to have uploaded may be conveyed to Bob in an input of Tx₁₋ₜₑₘₚₗₐₜₑ. Note this is not shown in FIG. 7. In principle this could be included in any of the instances of the first transaction (Tx₁₋ₜₑₘₚₗₐₜₑ, Tx₁′, Tx₁′″, etc.) sent from Alice to Bob. For simplicity the following will now use the symbol Tx₁ to refer to any instance of the first transaction sent from Alice to Bob. The data payload D could be included in the same input as points to the output of the source transaction Tx₀, or it could be included in another input such as a null or redundant input. Optionally, it may be included in conjunction with an opcode of the relevant script language which tells any node 104 receiving this instance of the first transaction to ignore the data D, e.g. by discarding it from its stack. By way of example, in Script this opcode is the OP_DROP opcode, though it will be appreciated that similar functionality could be achieved with other script languages. Although the intention would be to remove D before any instance of Tx₁ is published to the network 106 (and instead include it in Txₚ once a price is agreed with Bob), the OP_DROP opcode (or such like) means that if it did get published, the presence of the data payload D would not invalidate the first transaction.

Because the inputs of a transaction do not need to be signed as part of Alice or Bob's cryptographic signature, this means the data D (and if present the opcode) can be removed before publishing the first transaction to the network 106 without invalidating it.

Alice sends an instance of Tx₁ to Bob. Tx₁ contains in the unlocking script of its input: <data> OP_DROP. The output of Tx₁ only specifies a slightly larger amount of the digital asset than its input, say by ˜500 units. But <data> is large. The combination of these two facts means Tx₁ in itself is not (yet) worthwhile for anyone to mine (even if Alice's input is included at this stage to make it valid). However, the unlocking scripts of transaction inputs are not signed, and are therefore malleable. This means <data> OP_DROP is not signed, and can be removed without invalidating the transaction. This provides a convenient way to package and send the data to Bob.

The output of Tx₁ contains a locking script that enables the output to be spent if either: i) the unlocking script in the input of Txₚ contains the Bob's signature and the data (tested by means of a hash challenge—the locking script of Tx₁ contains the hash of the data and script which hashes a raw version provided in the unlocking script of Txₚ to check the values match); or ii) the unlocking script in the input of Txₚ contains Alice's signature, and a time-out limit has expired.

Tx₁ (or a subsequent instance of it) will need to be valid and accepted onto the blockchain if Txₚ is to be valid. If the data was sent in Tx₁, Bob removes <data> OP_DROP. Bob then sends Tx₁, or a later instance of it, off to the network 106 to be mined. The smaller size of the transaction means it is now worthwhile for other miners to mine. Alternatively Bob could mine it himself.

As an example implementation, the script included in the input of Tx₁ could look like this:

```
{
  “version”: 1,
  “locktime”: 0,
  “vin”: [
    {
      “txid”: “7957a35fe64f80d234d76d83a2a8f1a0d8149a41d81de548f0a65a8a999f6f18”,
      “vout”: 0,
      “scriptSig” : “<data> OP_DROP <Alice's signature> <Alice's public key>”,
      “sequence”: 4294967295
    }
  ],
  “vout”: [
    {
      “value”: 0.01500000,
      “scriptPubKey”: “OP_SHA256 <Hash of data> OP_EQUALVERIFY OP_IF OP_DUP
OP_HASH160 <Hash of Bob's public key> OP_ELSE <1000 blocks>
OP_CHECKSEQUENCEVERIFY OP_DROP OP_DUP OP_HASH160 <Hash of Alice's public key>
OP_ENDIF OP_EQUALVERIFY OP_CHECKSIG”
    }
  ]
}
```

A couple of remarks on this transaction: firstly, scriptSig—this is the unlocking script for Alice's unspent output. Three extra script elements have been added: OP_PUSHDATA, DATA, and OP_DROP. Note that Alice's signature is signed on the entire transaction without scriptSig. Therefore, adding extra elements in scriptSig does not invalidate her digital signature. In the present case, it does not invalidate the transaction either because OP_DROP will return the stack to its original state. To include the data in this part will allow Bob to receive the data and prune the data before publishing the transaction. Bob is going to publish the data in his unlocking script instead.

Secondly, scriptPubKey—this is the locking script that locks Bob's payment. To translate it to plain English, Bob needs to provide the data and his digital signature in order to claim the payment. Otherwise, after 1000 blocks, Alice can claim the payment back with her signature. Therefore, in order to get the payment, Bob is forced to include Alice's data in the unlocking script and therefore put the data on the blockchain 150.

Instead of broadcasting the transaction to the network 106, Alice sends the transaction Tx₁ to Bob over the side channel 301. Upon receiving the transaction, Bob parses the transaction to get the data and verifies its hash value. If the hash value is equal to the hash value provided in the scriptPubKey, then Bob is confident that he will be able to claim the payment. Therefore, Bob prunes “<data> OP_DROP” from the scriptSig in Alice's transaction then broadcasts the modified transaction to the network (or sends back to Alice over the side channel 301 to continue negotiating). Bob constructs another transaction Txₚ, shown below, to claim the payment and includes it in the next block 151 he mines.

By way of example, the unlocking script in Txₚ could look like this:

```
{
  “version”: 1,
  “locktime”: 0,
  “vin”: [
    {
      “txid”: “99f6f185fe64f80d234d76d83a2a8f1a0d8147957a3e548f0a65a8a99a41d81d”,
      “vout”: 0,
      “scriptSig” : “<Bob's signature> <Bob's public key> <data>”,
      “sequence”: 4294967295
    }
  ],
  “vout”: [
    {
      “value”: 0.01500000,
      “scriptPubKey”: “OP_DUP OP_HASH160 <Hash of Bob's public key> OP_EQUALVERIFY
OP_CHECKSIG”
    }
  ]
}
```

Once Alice sees Bob's transaction is confirmed on the blockchain 150, she can check that her data is indeed included in the transaction and hence on the blockchain 150.

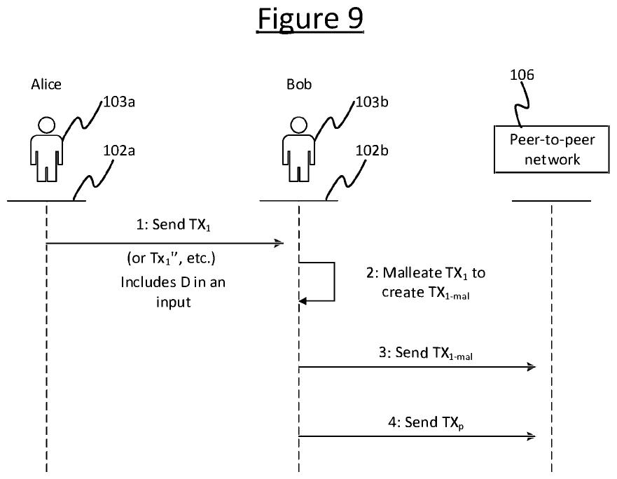

The instance of the first transaction Tx₁ shown in FIG. 9 could represent any of the instances of the first transaction sent from Alice to Bob over the side channel. The malleated instance Tx₁₋ₘₐₗ could represent a malleated version of any of the instances of the first transaction. The pre-negotiation could occur before, after and/or including the instance of the first transaction that includes the data Dis sent from Alice to Bob in FIG. 9.

Optionally, it is possible to enforce the pruning of <data> from Alice's transaction using a simple transaction fee constraint. This means that Alice has minimal risk of the data being mistakenly uploaded in her own transaction if Bob fails to prune it before sending to the network. We assume the minimum fee in units of the digital asset per-byte for relaying transactions on the network is Fₘᵢₙ. The byte-size of Alice's transaction is S_{Tx}=S_{data}+Sₒₜₕₑᵣ, where S_{data} is the byte-size of the data packet <data>.

The total fee F for Alice's transaction is calculated as the difference in value Vᵢₙ-Vₒᵤₜ between the inputs and outputs of Alice's transaction divided by its total size S_{Tx}. The condition for Alice's transaction to be successfully broadcast and validated is then:

$$\frac{{V}_{i n} - {V}_{o u t}}{{S}_{T x}} \geq {F}_{min} , {V}_{i n} - {V}_{o u t} \geq {F}_{min} \cdot ( {S}_{d a t a} + {S}_{other} ) .$$

Therefore, Alice can force Bob to prune the packet <data> before broadcasting the transaction by ensuring that the difference in value of her input and output satisfies relation:

Vᵢₙ−Vₒᵤₜ=Fₘᵢₙ·(Sₒₜₕₑᵣ)

which means that her fee will only cover the network minimum if Bob removes the entire data packet from Alice's initial transaction.

### Conclusion

It will be appreciated that the above embodiments have been described by way of example only.

For instance, the scope of the disclosed scheme is not limited to the scenario described in the Detailed Description whereby Bob is a miner and Alice is negotiating for him to upload a large item of data such as a document or movie clip to the chain. More generally, the disclosed mechanism of exchanging template or proposed transactions over a side channel 301 could be used to provide an interoperable mechanism for Alice to negotiate the provision of any service from Bob, e.g. IT support, information services, or provision of physical goods.

According to one aspect disclosed herein there is provided a computer-implemented method for recording in a blockchain at least a first transaction transferring an amount of a digital asset from a first party to a second party, wherein a copy of the blockchain is maintained across at least some of a network of nodes. The method comprises, at computer equipment of the first party: establishing a side channel separate from said network, the side channel being established between a first application on the computer equipment of the first party and a second application on computer equipment of the second party; and performing a negotiation procedure over the side channel. This procedure comprises: a) formulating a proposed instance of the first transaction and sending the proposed instance to the second party over the side channel, the proposed instance being formulated according to a transaction protocol recognized by the nodes of the network for validating transactions, and specifying a set of one or more values of a respective one or more parameters of the transaction including at least said amount of the digital asset, b) upon the second party not accepting the proposed instance of the first transaction, receiving back over the side channel a counter-proposed instance of the first transaction, the counter-proposed instance also being formulated according to the transaction protocol, but specifying a modified set of one or more values of the one or more transaction parameters, and c) the first party selecting whether to accept the counter-proposed instance received in b).

The modified set of values may modify one, some or all of the values compared to the first set. The parameters whose values are modified may comprise the amount of the digital asset, and/or one or more other parameters such as a lock time.

In embodiments, c) may comprise: reading the modified set of one or more values from the counter-proposed instance of the first transaction received in b), and performing said selection as to whether to accept the counter-proposed instance based on an assessment of the modified set of values as read therefrom.

In embodiments, c) may comprise: upon selecting not to accept the counter-proposed instance received in b), formulating a further counter-proposed instance of the first transaction and sending the further counter-proposed instance to the second party over the side channel for the second party to accept, the further counter-proposed instance again being formulated according to the transaction protocol but specifying a further set of one or more values of the one or more transaction parameters.

In embodiments, c) may comprise: determining the further set of one or more values in dependence on the modified set of values as read from the counter-proposed instance of the first transaction received in b).

In embodiments, at least in a first occurrence of b), the second party does may not accept the further counter-proposed transaction and instead, following c), the procedure returns to b) and continues from b) until one of the parties accepts one of the counter-proposed transactions or further counter-proposed transactions.

In embodiments, the continuation of the procedure may comprise at least one repeated occurrence of both b) and c).

The further modified set of values may modify one, some or all of the values compared to the previously modified set. Again the parameters whose values are modified may comprise the amount of the digital asset, and/or one or more other parameters such as a lock time.

In embodiments, the acceptance may comprises the accepted instance of the first transaction being sent to be propagated over the network and thereby recorded in the blockchain.

In embodiments, the first party accepts one of the counter-proposals from the second party, by the first party sending the accepted instance of the first transaction to be propagated over the network.

Alternatively, one of the further counter-proposed instances from the first party is accepted by the second party, the accepted instance being sent by the second party to be propagated over the network.

Note: the acceptance and sending could comprise the initiating party sending the accepted instance of the first transaction back to the other party for the other party to forward to the network, or sending the acceptance instance to a third party for the third party to forward to the network, or even sending the first transaction back to the other party for the other party to forward to a third party for the third party to forward onward to the network. Similarly, the acceptance and sending by the other party could comprise the other party sending the accepted instance of the first transaction back to the initiating party for the initiating party to forward to the network, or sending the acceptance instance to a third party for the third party to forward to the network, or even sending the first transaction back to the initiating party for the initiating party to forward to a third party for the third party to forward onward to the network. “Sending to be propagated” herein does not necessarily require that the party that performs this step sends the transaction directly to the network him/herself (though that is of course one option).

In embodiments, the proposed instance of the first transaction in a) may take the form of a template transaction having a complete part and an incomplete part, and therefore not yet being valid according to the node protocol, the proposed transaction being formulated according to the transaction protocol at least in that the complete part is formulated according to the transaction protocol; and the accepted instance may have the incomplete parted completed by the first and/or second party.

In embodiments, each instance of the first transaction may comprise at least a first output specifying the amount and comprising an unlocking script, the unlocking script specifying at least one condition to be met by an unlocking script in an input of a second transaction in order to unlock the first output and thereby redeem said amount of the digital asset.

In embodiments, the complete part may comprise zero or more inputs in total and one or more outputs in total including at least the first output, and the template transaction may be invalid at least in that the one or more outputs specify a total output value of the digital asset greater than a total input value of the zero or more inputs. In this case the completion of the incomplete part comprises at least one input being added to make the total input value equal to or greater than the total output value.

In embodiments, the complete part may comprise zero or more inputs and one or more outputs including at least the first output, and the template transaction is invalid at least in that it lacks a cryptographic signature of the first and/or second party. In this case the completion of the incomplete part comprises the signature of the first and/or second party being added in one or more existing inputs.

The template transaction could comprise one or more existing, incomplete inputs that are missing the signature of the first and/or second party, or the template transaction may comprise one or more missing inputs. The adding of the signature(s) may comprise at least one new input being added including the signature of the first and/or second party, or the signature of the first and/or second party being added to one or more existing inputs. In the case where both the signatures of the first and second party are required, these could be included in the same input or different respective first and second inputs.

In embodiments, the proposed instance of the first transaction in a) may comprise no inputs and the first output; the counter-proposed instance from the second party in at least a final occurrence of b) may comprise a signature of the second party; and the accepted instance may comprise an input added by the first party making the total input value equal to or greater than the total output value, and comprising the signature of the first party.

E.g. the signature of the second party may be included in an input added by the second party to the counter-proposed instance of the first transaction.

In embodiments the first party may initiate the procedure by performing a). Alternatively, in embodiments, the procedure may be initiated by: at the computer equipment of the first party, obtaining an advertisement transaction from the second party, the advertisement transaction comprising an unspendable output specifying an advertised set of one or more values for the one or more parameters; and wherein the first set of one or more values of the one or more transaction parameters proposed by the first party are modified relative to the advertised set.

The advertisement transaction may for example be received over the side channel, or retrieved by the first party from a public data source, or received via a third party.

In embodiments, the advertisement transaction may further comprise an input containing the cryptographic signature of the second party, thus providing the first party with the option of, instead of an instance of the first transaction, accepting the advertisement transaction by adding an input containing the signature of the first party.

In embodiments, the second party may be a miner, and said amount of the digital asset may provide a payment for the second party to perform a proof-of-work operation to have a version of a second transaction comprising a data payload included in a block of the blockchain. The locking script may require at least that an unlocking script in an input of the second transaction comprises the data payload in order to redeem the payment.

In embodiments, the requirement to include the data payload may be enforced by a hash challenge included in the locking script, the hash challenge comprising a hash of the data payload and a hash function to check that a hash of the data payload from the unlocking script matches the hash included in the locking script.

In embodiments, the data payload may for example comprise a document comprising text, and/or a media content comprising audio and/or video.

In embodiments, the data payload is conveyed from the first party in a part of one of the instances of the first transaction that is not required to be signed, thereby enabling the data payload to be removed from the first transaction before being sent to be propagated over the network.

E.g. the data payload may be conveyed in an input of one of the instances of the first transaction sent from the first party to the second party. It may be included in a script accompanied by an opcode, e.g. OP_DROP, that would cause any node 104 executing the script to ignore the data.

In other embodiments the second party need not be a miner, and said amount of the digital asset may be used to provide a payment for the second party to perform some other service for the first party, such as the provision of goods, home renovation work, consultancy services, etc.

In embodiments, the set of transaction parameters in each instance of the first transaction may further comprise a lock time after which the first party can claim back the amount of digital asset if not yet redeemed by the second party.

The lock time may for example be specified in units of time (human time, e.g. ms, seconds, minutes, hours, weeks, months or years, or such like) or in terms of a number of transactions or blocks mined. The lock time may be specified as an absolute point in time, or as a relative lock time, i.e. an amount of time to elapse from a defined point going forward, e.g. from the point at which said first transaction is mined.

In embodiments, the value of the lock time may be modified between two or more of the proposed, counter-proposed and further counter-proposed instances of the first transaction.

In embodiments, the locking script in each instance of the first transaction may specify a plurality of alternative conditions for redeeming the payment, comprising at least: i) a first condition requiring that the unlocking script of a first version of the second transaction includes the data payload, and ii) a second condition requiring that the lock time has expired and the unlocking script of a second version of the second transaction includes a cryptographic signature of the first party.

In embodiments, the first condition may further require that a cryptographic signature of the second party is included in the unlocking script.

In embodiments, the first and second applications may share no common negotiation protocol for negotiating transactions over the side channel other than said procedure using the transaction protocol.

In embodiments, the first and second client applications of the initiating party may be produced by different developers, or are different releases by a same developer.

In embodiments, no other negotiation messages need be exchanged between the first and second parties, other than transactions formulated according to said transaction protocol, in order to negotiate an accepted instance of the first transaction.

According to another aspect of the present disclosure, there is provided a computer program embodied on computer-readable storage and configured so as when run on the computer equipment of the first party to perform the method of the first party according to any embodiment disclosed herein.

According to another aspect of the present disclosure, there is provided the computer equipment of the first party, comprising: memory comprising one or more memory units, and processing apparatus comprising one or more processing units; wherein the memory stores code arranged to run on the processing apparatus, the code being configured so as when on the processing apparatus to carry out the method of the first party according to any embodiment disclosed herein.

According to another aspect of the present disclosure, there is provided a computer-implemented method for recording in a blockchain at least a first transaction transferring an amount of a digital asset from a first party to a second party, wherein a copy of the blockchain is maintained across at least some of a network of nodes. The method comprising, at computer equipment of the second party: establishing a side channel separate from said network, the side channel being established between a first application on the computer equipment of the first party and a second application on computer equipment of the second party; and performing a negotiation procedure over the side channel. This procedure comprises: a) receiving a proposed instance of the first transaction from the first party over the side channel, the proposed instance being formulated according to a transaction protocol recognized by the nodes of the network for validating transactions, and specifying a set of one or more values of a respective one or more parameters of the transaction including at least said amount of the digital asset, and b) the second party selecting not to accept the proposed instance of the first transaction, and instead sending back over the side channel a counter-proposed instance of the first transaction, the counter-proposed instance also being formulated according to the transaction protocol, but specifying a modified set of one or more values of the one or more transaction parameters.

In embodiments the method may further comprises steps of the second party in accordance with any embodiment disclosed herein.

According to another aspect of the present disclosure, there is provided a computer program embodied on computer-readable storage and configured so as when run on the computer equipment of the second party to perform the method of the second party according to any embodiment disclosed herein.

According to another aspect of the present disclosure, there is provided the computer equipment of the second party, comprising: memory comprising one or more memory units, and processing apparatus comprising one or more processing units; wherein the memory stores code arranged to run on the processing apparatus, the code being configured so as when on the processing apparatus to carry out the method of the second party according to any embodiment disclosed herein.

Other variants or use cases of the disclosed techniques may become apparent to the person skilled in the art once given the disclosure herein. The scope of the disclosure is not limited by the described embodiments but only by the accompanying claims.

1. A computer-implemented method for recording in a blockchain at least a first transaction transferring an amount of a digital asset from a first party to a second party, wherein a copy of the blockchain is maintained across at least some of a network of nodes;
the method comprising, at computer equipment of the first party:
establishing a side channel separate from said network, the side channel being established between a first application on the computer equipment of the first party and a second application on computer equipment of the second party; and
performing a procedure comprising the steps of:
a) a first step of formulating a proposed instance of the first transaction and sending the proposed instance to the second party over the side channel, the proposed instance being formulated according to a transaction protocol recognized by the nodes of the network for validating transactions, and specifying a set of one or more values of a respective one or more parameters of the transaction including at least said amount of the digital asset,
b) a second step of, upon the second party not accepting the proposed instance of the first transaction, receiving back over the side channel a counter-proposed instance of the first transaction, the counter-proposed instance also being formulated according to the transaction protocol, but specifying a modified set of one or more values of the one or more transaction parameters, and
c) a third step of the first party selecting whether to accept the counter-proposed instance received in b) the second step.

2. The method of claim 1, wherein c) the first step comprises reading the modified set of one or more values from the counter-proposed instance of the first transaction received in b) the second step, and performing said selection as to whether to accept the counter-proposed instance based on an assessment of the modified set of values as read therefrom.

3. The method of claim 1, wherein c) the first step comprises, upon selecting not to accept the counter-proposed instance received in b) the second step, formulating a further counter-proposed instance of the first transaction and sending the further counter-proposed instance to the second party over the side channel for the second party to accept, the further counter-proposed instance again being formulated according to the transaction protocol but specifying a further set of one or more values of the one or more transaction parameters.

4. The method of claim 2, wherein:
c) the third step comprises, upon selecting not to accept the counter-proposed instance received in b) the second step, formulating a further counter-proposed instance of the first transaction and sending the further counter-proposed instance to the second party over the side channel for the second party to accept, the further counter-proposed instance again being formulated according to the transaction protocol but specifying a further set of one or more values of the one or more transaction parameters; and
the further set of one or more values are determined in dependence on the modified set of values as read from the counter-proposed instance of the first transaction received in b) the second step.

5. The method of claim 3, wherein at least in a first occurrence of b) the second step the second party does not accept the further counter-proposed transaction and instead, following c) the third step, the procedure returns to b) the second step and continues from b) the second step until one of the parties accepts one of the counter-proposed transactions or further counter-proposed transactions.

6. The method of claim 5, wherein the continuation of the procedure comprises at least one repeated occurrence of both b) the second step and c) the third step.

7. The method of claim 1 wherein the acceptance comprises: the accepted instance of the first transaction being sent to be propagated over the network and thereby recorded in the blockchain.

8. The method of claim 7, comprising the first party accepting one of the counter-proposals from the second party, by the first party sending the accepted instance of the first transaction to be propagated over the network.

9. The method of claim 7, wherein one of the further counter-proposed instances from the first party is accepted by the second party, the accepted instance being sent by the second party to be propagated over the network.

10. The method of claim 7, wherein:
the proposed instance of the first transaction in a) the first step takes the form of a template transaction having a complete part and an incomplete part, and therefore not yet being valid according to the node protocol, the proposed transaction being formulated according to the transaction protocol at least in that the complete part is formulated according to the transaction protocol; and
the accepted instance has the incomplete parted completed by the first and/or second party.

11. The method of claim 1 wherein each instance of the first transaction comprises at least a first output specifying the amount and comprising an unlocking script, the unlocking script specifying at least one condition to be met by an unlocking script in an input of a second transaction in order to unlock the first output and thereby redeem said amount of the digital asset.

12. The method of claim 10, wherein:
each instance of the first transaction comprises at least a first output specifying the amount and comprising an unlocking script, the unlocking script specifying at least one condition to be met by an unlocking script in an input of a second transaction in order to unlock the first output and thereby redeem said amount of the digital asset and
the complete part comprises zero or more inputs in total and one or more outputs in total including at least the first output, and the template transaction is invalid at least in that the one or more outputs specify a total output value of the digital asset greater than a total input value of the zero or more inputs; and the completion of the incomplete part comprises at least one input being added to make the total input value equal to or greater than the total output value.

13. The method of claim 10, wherein:
each instance of the first transaction comprises at least a first output specifying the amount and comprising an unlocking script, the unlocking script specifying at least one condition to be met by an unlocking script in an input of a second transaction in order to unlock the first output and thereby redeem said amount of the digital asset; and
the complete part comprises zero or more inputs and one or more outputs including at least the first output, and the template transaction is invalid at least in that it lacks a cryptographic signature of the first and/or second party; and the completion of the incomplete part comprises the signature of the first and/or second party being added in one or more existing inputs.

14. The method of any of claims 11, wherein:
c) the third step comprises, upon selecting not to accept the counter-proposed instance received in b) the second step, formulating a further counter-proposed instance of the first transaction and sending the further counter-proposed instance to the second party over the side channel for the second party to accept, the further counter-proposed instance again being formulated according to the transaction protocol but specifying a further set of one or more values of the one or more transaction parameters;
the acceptance comprises: the accepted instance of the first transaction being sent to be propagated over the network and thereby recorded in the blockchain;
the proposed instance of the first transaction in a) the first step comprises no inputs and the first output;
the counter-proposed instance from the second party in at least a final occurrence of b) the second step comprises a signature of the second party; and
the accepted instance comprises an input added by the first party making a total input value equal to or greater than a total output value, and comprising the signature of the first party.

15. (canceled)

16. The method of claim 1, wherein the procedure is initiated by, at the computer equipment of the first party, obtaining an advertisement transaction from the second party, the advertisement transaction comprising an unspendable output specifying an advertised set of one or more values for the one or more parameters; and wherein the first set of one or more values of the one or more transaction parameters proposed by the first party are modified relative to the advertised set.

17. The method of claim 16, wherein the advertisement transaction further comprises an input containing a cryptographic signature of the second party, thus providing the first party with an option of, instead of an instance of the first transaction, accepting the advertisement transaction by adding an input containing a signature of the first party.

18. The method of claim 10, wherein:
the second party is a miner, said amount of the digital asset providing a payment for the second party to perform a proof-of-work operation to have a version of a second transaction comprising a data payload included in a block of the blockchain; and
the locking script requires at least that an unlocking script in an input of the second transaction comprises the data payload in order to redeem the payment.

19. The method of claim 18, wherein the requirement to include the data payload is enforced by a hash challenge included in the locking script, the hash challenge comprising a hash of the data payload and a hash function to check that a hash of the data payload from the unlocking script matches the hash included in the locking script.

20. (canceled)

21. The method of claim 18, wherein the data payload is conveyed from the first party in a part of one of the instances of the first transaction that is not required to be signed, thereby enabling the data payload to be removed from the first transaction before being sent to be propagated over the network.

22-25. (canceled)

26. The method of claim 1, wherein the first and second applications share no common negotiation protocol for negotiating transactions over the side channel other than said procedure using the transaction protocol.

27. The method of claim 1 wherein the first and second applications are produced by different developers, or are different releases by a same developer.

28. The method of claim 1 wherein no other negotiation messages are exchanged between the first and second parties, other than transactions formulated according to said transaction protocol, in order to negotiate an accepted instance of the first transaction.

29. A computer program for recording in a blockchain at least a first transaction transferring an amount of a digital asset from a first party to a second party, wherein a copy of the blockchain is maintained across at least some of a network of nodes, the computer program being embodied on non-transitory computer-readable storage and configured so as when run on computer equipment of the first party to perform a method of:
establishing a side channel separate from said network, the side channel being established between a first application on the computer equipment of the first party and a second application on computer equipment of the second party; and
performing a procedure comprising:
a) formulating a proposed instance of the first transaction and sending the proposed instance to the second party over the side channel, the proposed instance being formulated according to a transaction protocol recognized by the nodes of the network for validating transactions, and specifying a set of one or more values of a respective one or more parameters of the transaction including at least said amount of the digital asset,
b) upon the second party not accepting the proposed instance of the first transaction, receiving back over the side channel a counter-proposed instance of the first transaction, the counter-proposed instance also being formulated according to the transaction protocol, but specifying a modified set of one or more values of the one or more transaction parameters, and
c) the first party selecting whether to accept the counter-proposed instance received in b).

30. Computer equipment of a first party, comprising:
memory comprising one or more memory units, and
processing apparatus comprising one or more processing units;
wherein the memory stores code arranged to run on the processing apparatus, the code being configured so as when on the processing apparatus to carry out a method for recording in a blockchain at least a first transaction transferring an amount of a digital asset from the first party to a second party, wherein a copy of the blockchain is maintained across at least some of a network of nodes, the method comprising:
establishing a side channel separate from said network, the side channel being established between a first application on the computer equipment of the first party and a second application on computer equipment of the second party; and
performing a procedure comprising:
a) formulating a proposed instance of the first transaction and sending the proposed instance to the second party over the side channel, the proposed instance being formulated according to a transaction protocol recognized by the nodes of the network for validating transactions, and specifying a set of one or more values of a respective one or more parameters of the transaction including at least said amount of the digital asset,
b) upon the second party not accepting the proposed instance of the first transaction, receiving back over the side channel a counter-proposed instance of the first transaction, the counter-proposed instance also being formulated according to the transaction protocol, but specifying a modified set of one or more values of the one or more transaction parameters, and
c) the first party selecting whether to accept the counter-proposed instance received in b).

31. A computer-implemented method for recording in a blockchain at least a first transaction transferring an amount of a digital asset from a first party to a second party, wherein a copy of the blockchain is maintained across at least some of a network of nodes; the method comprising, at computer equipment of the second party:
establishing a side channel separate from said network, the side channel being established between a first application on the computer equipment of the first party and a second application on computer equipment of the second party;
performing a procedure comprising:
a) receiving a proposed instance of the first transaction from the first party over the side channel, the proposed instance being formulated according to a transaction protocol recognized by the nodes of the network for validating transactions, and specifying a set of one or more values of a respective one or more parameters of the transaction including at least said amount of the digital asset, and
b) the second party selecting not to accept the proposed instance of the first transaction, and instead sending back over the side channel a counter-proposed instance of the first transaction, the counter-proposed instance also being formulated according to the transaction protocol, but specifying a modified set of one or more values of the one or more transaction parameters.

32-33. (canceled)
